(19) United States
(12) Patent Application Publication
(10) Pub. No.: US 2008/0103952 A1
(43) Pub. Date: May 1, 2008

(54) SPECIFYING AND NORMALIZING UTILITY FUNCTIONS OF PARTICIPANTS IN AN ADVERTISING EXCHANGE

(75) Inventors: Gary W. Flake, Bellevue, WA (US); Brett D. Brewer, Sammamish, WA (US); Christopher A. Meek, Kirkland, WA (US); David Max Chickering, Bellevue, WA (US); Jody D. Biggs, Redmond, WA (US); Ewa Dominowska, Kirkland, WA (US); Brian Burdick, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/735,742

(22) Filed: Apr. 16, 2007

Related U.S. Application Data
(60) Provisional application No. 60/862,969, filed on Oct. 25, 2006.

(51) Int. Cl. G06Q 40/00

(52) U.S. Cl. 705/37; 705/40; 705/400

(57) ABSTRACT

For a multi-party advertising exchange including advertising and publishing entities, each participant can specify one or more utility functions that are invertible with respect to a common measure, such as revenue. In one non-limiting embodiment, each utility function is invertible with respect to expected revenue per standard advertising unit, e.g., expected cost per impression. The disparate utility functions of multiple participants are also normalized within the advertising exchange by converting the utility functions to the common measure enabling the comparison or translation of a first set of utility functions to a second set of utility functions in quantifiable terms. Various system refinements are provided and disclosed according to a host of optional embodiments.

### TECHNICAL FIELD

The subject disclosure relates to the specification and normalization of utility functions for participants in online advertising architectures and environments.

### BACKGROUND

Conventionally, large web search engines have sold advertising space based on keyword-driven search results. For example, Yahoo! conducts auctions for certain keywords, and the highest bidders have their ads placed on pages containing Yahoo! search results, or they obtain preferred placement among the search results, i.e., at the top of the results list.

As web advertising has developed, a number of companies are acquiring large publisher bases from which they can sell advertisements. For instance, Google is signing up publishers into their AdSense ad network to broker publishing space from the publishers to a set of participating advertisers bidding for and purchasing the advertising space. Advertisers pay Google to serve advertisements to participants of the AdSense network. Google then pays some or all of the advertising revenue to the individual publishers. For example, a publisher in the AdSense network may have an article on its website that talks about digital cameras, and Google's AdSense displays digital camera advertisements from advertisers in the AdSense network on that website. Google auctions off the “digital camera” keyword to advertisers in its AdSense network and displays ads from the highest bidders.

However, there are a number of problems with this proprietary ad network model. First, companies that are building ad networks have an inherent conflict of interest because, as a broker for advertising deals, they represent both the publisher and the advertiser. Second, because there are multiple companies that are creating ad networks, advertisers have the burden of managing buys across many ad networks, which results in significant cost and complexity to the advertiser. Third, because publishers are for all practical purposes locked into a single ad network due to legal restrictions when signing up, the advertiser competition is limited, which results in lower return for the publishers. Fourth, the lack of general standards around terms and conditions, and behavioral segmentation is a major obstacle to reaching the full market value of online display advertising. There is also no current standardization across publishers for accepted media types and ad formats. Fifth, smaller publishers currently have very little power individually, even if they serve a hard-to-reach audience. Additionally, ISPs and other owners of large user databases are not realizing the full value of the information they have due to privacy concerns and lack of a proper marketplace.

For instance, elaborating on the lack of standards around terms and conditions of existing advertising transactions, there are a variety of disparate items in an advertising exchange that should be able to be compared despite disparate definitions. An example of this lack of standards is with respect to utility functions for participants in an exchange. Oftentimes, when there are multiple advertisers bidding for the same publisher space, or when multiple publishers are competing for the same advertisers, each participant to the transaction may have different utility functions, which today manifest themselves in a variety of ways, and according to a variety of biases.

As a relatively simple example, an advertiser may wish to minimize risk and might express transactions in terms of cost per acquisition (CPA), a measure of how much the advertiser will pay to actually gain a specific result from a customer. On the flip side, another advertiser with a different risk profile may instead wish to express transactions in terms of cost per impressions (CPI) to minimize the risk. Today, there is no way to receive both kinds of bids for the same advertising space in an ad network. This is just a simple example as well. When one takes into consideration the myriad of other types of biases an advertiser or publisher may exhibit (e.g., preference for relevance, preference for quality, preference for time of day, preference for ecologically sound companies, etc.) in an exchange as part of an expression of a utility function, there is simply no way to compare these measures for the different utility functions directly, or translate them across participants by a normalizing function, so by in large, participants must guess at other participants' utility functions. Thus, what is desired is a way to specify utility functions per participant of an advertising exchange, and to normalize disparate utility functions of multiple participants within the advertising exchange.

The above-described deficiencies of current advertising environments are merely intended to provide an overview of some of the problems of today's advertising environments, and are not intended to be exhaustive. Other problems with the state of the art may become further apparent upon review of the description of various non-limiting embodiments of the invention that follows.

### SUMMARY

For a multi-party advertising exchange including advertising and publishing entities, the invention enables each participant to specify one or more utility functions that are invertible with respect to a common measure, such as revenue. In one non-limiting embodiment, each utility function is invertible with respect to expected revenue per standard advertising unit, e.g., expected cost per impression. The disparate utility functions of multiple participants are also normalized within the advertising exchange by converting the utility functions to the common measure enabling the comparison or translation of a first set of utility functions to a second set of utility functions in quantifiable terms.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

Various embodiments of the specifying and normalizing of utility functions for online advertising in accordance with the present invention are further described with reference to the accompanying drawings in which:

FIG. 1 is a block diagram of a computing system environment suitable for use in implementing the present invention;

FIG. 2 illustrates a distributed architecture for online advertising, according to embodiments of the present invention;

FIG. 3 illustrates one example of the flow of data within architecture 200, according to embodiments of the present invention;

FIG. 4 illustrates a flowchart of the operation of an exchange, according to embodiments of the present invention;

FIG. 5 illustrates a flowchart of the operation of an audience data broker, according to embodiments of the present invention;

FIGS. 6A and 6B are exemplary non-limiting block diagrams of embodiments of an online advertising exchange in accordance with the invention;

FIG. 7 is an exemplary block diagram illustrating an alternate embodiment of an online advertising exchange in accordance with the invention;

FIG. 8 illustrates another exemplary block diagram illustrating an alternate embodiment of an online advertising exchange in accordance with the invention;

FIG. 9B illustrates exemplary processes for conversion tracking in a distributed online advertising exchange;

FIG. 10 illustrates non-linear weighting of clickthrough rates in an exemplary non-limiting embodiment of the invention;

FIG. 11 illustrates non-linear weighting of conversion rates in an exemplary non-limiting embodiment of the invention;

FIG. 12 illustrates another exemplary block diagram illustrating the normalizing of disparate broker rules in an online advertising exchange in accordance with the invention;

FIGS. 13A and 13B illustrate exemplary normalization of disparate formats for expressing transactions in an online advertising exchange in accordance with the invention;

FIGS. 14A and 14B are exemplary, non-limiting block diagram illustrations of normalizing transactions in an online advertising exchange based on expected cost per impression as a common measure in accordance with the invention;

FIG. 15 illustrates automatic revenue sharing as a feature enabled by the normalization of utility functions in accordance with the invention;

FIGS. 16A and 16B illustrate exemplary tools and ways for participants to express one or more utility functions for normalization by an online advertising exchange in accordance with the invention;

FIGS. 17A and 17B illustrate exemplary ranges or continuums along a spectrum for defining one or more utility functions in accordance with the invention;

FIG. 18 is a block diagram illustrating the filtering or weighting of utility functions that may be specified by a participant to an online advertising exchange in accordance with the invention; and

FIG. 19 is a flow diagram illustrating an exemplary process for receiving and normalizing utility functions input by participants to an exchange in accordance with the invention.

### DETAILED DESCRIPTION

### Overview

In various non-limiting embodiments, the invention is described in the context of a distributed architecture for online advertising, i.e., a market mechanism that manages the exchange of advertising goods among multiple participants on the advertising and/or publishing side. For instance, for a multi-party advertising exchange, the invention enables each participant to specify one or more utility functions that are invertible with respect to a common measure. This allows disparate utility functions of multiple participants to be normalized within the advertising exchange enabling the comparison or translation of a first set of utility functions to a second set of utility functions in quantifiable terms.

Overall, increasing the amount of knowledge of parties to a transaction makes for a more efficient transaction since knowledge can reduce uncertainty and risk in decision making by the parties. In this respect, the invention increases the ability of participants to an advertising exchange to make more rational decisions about advertising transactions vis-à-vis other participants' utility functions. As a result, the advertising marketplace is better defined as between individual participants, making for more efficient and rational transactions among those participants, and yielding a more efficient marketplace for all.

In various non-limiting embodiments, an advertising system to facilitate trading of advertising includes (A) a publisher broker to represent publishers that determines an ask for an advertisement space on the publishers' inventory, such as a webpage, (B) an advertiser broker to represent advertisers that manages the advertisers' bids for the advertisement space and (C) an exchange to facilitate a transaction for the advertisement space between the publisher broker and the advertiser broker.

To specify utility functions per exchange participant, a tool is provided in accordance with the invention for defining one or more utility functions of the publisher broker or the advertiser broker. For instance, the tool enables explicit definition of pre-defined objectives or risk profiles of the publisher broker or the advertiser broker in an advertising context.

In other aspects, the invention enables direct comparisons of disparate utility functions of different participants by normalizing the disparate utility functions to a standard utility function representation within the advertising exchange. In one embodiment, the utility functions are constrained to invertible functions with respect to a common measure, such as revenue, or expected revenue per impression, for a given advertising transaction.

In another embodiment, different parties' utility functions may be specified according to different vocabularies. The exchange operates to normalize all of the utility functions of the different parties into a common currency. For instance, with respect to advertising, utility functions have typically been defined with respect to such metrics as cost per impression (CPI), cost per conversion (CPC) or cost per acquisition (CPA). Any party can specify a utility function based on any of these metrics, and based on known mappings between metrics, utility functions across different parties can be normalized.

In another embodiment, the specification of personal or private utility functions, i.e., each party can specify respective maximization functions based on different utility functions. Since each party has unique business goals and objectives, a wide variety of objectives may be toggled, or modified in accordance with the invention to specify party utility functions on a per party basis.

In yet another non-limiting embodiment, the invention collects and provides any useful information that will reduce the variance in the expected utility of a transaction. For instance, past performance tracking is provided as a service to participants in the exchange to help reduce the amount of variance in their expected outcomes in advertising transactions. As an example of past performance tracking, conversion rate tracking can be provided. Tracking publisher clickthrough rates (CTRs) for advertisers bidding on a cost per click (CPC) basis is another example where useful information can be tracked for participants to reduce risk relative to expected utility. For instance, if an advertiser is interested in CPC bidding (CPM bidding, revenue share), the exchange can provide CTRs (number of impressions, revenue generated) for the various publishers. Thus, given a general utility function, the exchange can provide information that will reduce the variance in expected utility for the advertisers with that utility function.

Such performance tracking information such as clickthrough rates or conversion rates is enabled for the exchange of the invention to provide a more solid understanding of performance for advertising because the information is provided across advertising networks and across different parties. In essence, it is known that by increasing one's performance for advertising, a marketer can lower the cost per acquisition without changing the cost paid for traffic. Even a small increase in performance can have a dramatic profit impact, and so it is desirable to find publishing space with a high expected performance. With performance tracking provided in the distributed framework for online advertising in accordance with the invention, pricing can be made more accurate because performance information is available across parties, averaging out individual transactional biases within any specific advertising network.

A simplified overview has been provided in the present section to help enable a basic or general understanding of various aspects of exemplary, non-limiting embodiments that follow in the more detailed description and the accompanying drawings. This overview section is not intended, however, to be considered extensive or exhaustive. Instead, the overview presents some concepts related to some exemplary non-limiting embodiments of the invention in a simplified form as a prelude to the more detailed description of these and various other embodiments of the invention that follow.

### Exemplary Operating Environment(s)

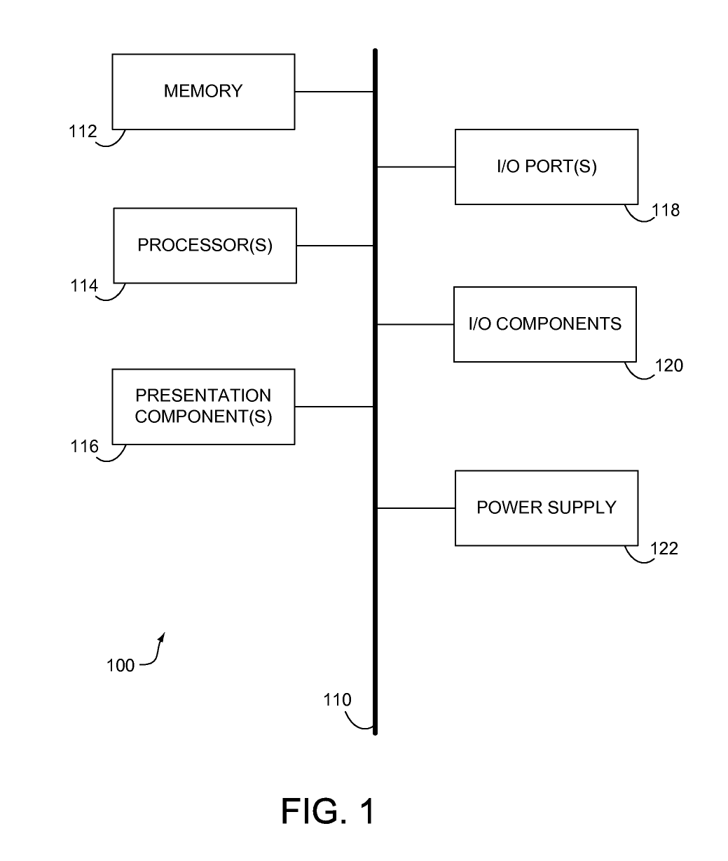

Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated. In accordance with the invention, participants can communicate with an advertising exchange via one or more computing devices 100, and the advertising exchange may also comprise one or more computing devices 100, in order to carry out one or more aspects of the invention described in detail below.

In this regard, the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following elements: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory, or otherwise communicate with memory. It should be noted that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

### Exemplary Architecture(s) for Online Advertising

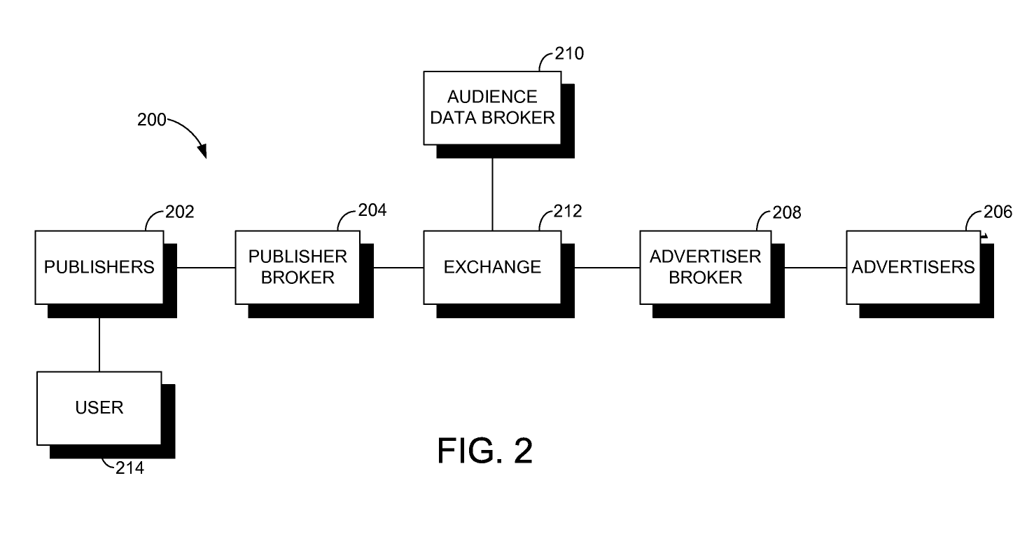

Exemplary online advertising environments or architectures in which one or more of the various embodiments of the specification and normalization of participant utility functions of the present invention may be deployed or implemented are now described. For instance, FIG. 2 illustrates an exemplary distributed architecture 200 for online advertising, which comprises publishers 202. For purposes of explanation only, publishers 202 will be discussed herein as a group of any number of publishers. However, embodiments of the present invention are not limited to a group of publishers, as a single publisher is sufficient. Also, embodiments of the present invention are not limited to a single group of publishers, as any number of groups of publishers may be present in architecture 200.

In an embodiment, each publisher is a content provider. For example, a construction worker who operates a single page website on which he posts a weblog (blog) may be a publisher. In another example, a media company such as Disney, who operates a huge website with many pages of content may also be a publisher. Publishers 202 is intended to represent any number of types, sizes, sophistication levels, etc. of publishers. In an embodiment, publishers 202 desire to sell advertisement space on their websites to advertisers 206 (discussed below).

Architecture 200 also comprises publisher broker 204. For purposes of explanation only, only one publisher broker will be discussed herein. However, embodiments of the present invention are not limited to a single publisher broker, as any number of publisher brokers may exist. In an embodiment, publisher broker 204 is an aggregator of publishers. Specifically, publisher broker 204 is an entity that represents publishers 202 with the goal of maximizing ad revenue, ensuring quality ads, etc. Publisher broker 204 breaks the conflict of interest that is inherent in systems such as Google's AdSense by solely focusing on managing publishers 202's yield. Publisher broker 204 allows small and mid-size publishers (such as those that may be represented by publishers 202) to aggregate in order to drive higher yield for themselves. In an embodiment, publisher broker 204 maintains a user interface through which it interacts with publishers 202 and through which it manages publishers 202's preferences.

In an embodiment, publisher broker 204 comprises a publisher center and a publisher delivery system. The publisher center allows publishers to manage their preferences. The publisher delivery system is used to calculate the ask for a given page view on the publisher's site, and potentially enrich the available user data in the request. In an embodiment, the ask is an asking price. However, embodiments are not so limited, as the ask may be, e.g., a minimum cost-per-click, minimum relevance, some other performance metric, etc.

The publisher center establishes traffic inventory groupings in the system and sets asks. When a user makes a page request to the publisher, the publisher populates their page with some scripting that sets up a call to the publisher broker. The publisher may add in some information about the user to the call to the publisher broker (the incentive would be that more publishers would want to use a publisher broker that had this sort of value added service). The publisher broker determines what the ask should be for a particular request, given the user information present, the inventory grouping that the request falls into, and the rules the publisher has set up around that information. Additionally, the publisher broker will pass along the maximum amount that the publisher is willing to pay to have any unknown data attributes about the user populated for this request. Finally, the publisher broker encodes this information into a request URL that it sends back to the user as a redirection URL. When all transactions have occurred in the exchange (see below), a call back is provided to the publisher broker stating whether and how many ads were displayed, what the publisher broker can expect in terms of a payment, and which incremental attributes about the user were filled by an audience broker (see below).

Architecture 200 also comprises advertisers 206. For purposes of explanation only, advertisers 206 will be discussed herein as a group of any number of advertisers. However, embodiments of the present invention are not limited to a group of advertisers, as a single advertiser is sufficient. Also, embodiments of the present invention are not limited to a single group of advertisers, as any number of groups of advertisers may be present in architecture 200.

In an embodiment, each advertiser purchases ad space on websites. For example, a local businessperson who operates a website for her small flower shop and who advertises on a neighborhood homeowners' association website may be an advertiser. In another example, a massive corporate entity such as General Motors, which has thousands of products and services, and which advertises on thousands of automotive-related websites may also be an advertiser. Advertisers 206 is intended to represent any number of types, sizes, sophistication levels, etc. of advertisers. In an embodiment, advertisers 206 desire to pay money to place ads on publishers 202's websites.

Architecture 200 also comprises advertiser broker 208. For purposes of explanation only, only one advertiser broker will be discussed herein. However, embodiments of the present invention are not limited to a single advertiser broker, as any number of advertiser brokers may exist. In an embodiment, advertiser broker 208 is an aggregator of advertisers. Specifically, advertiser broker 208 is an entity that represents advertisers 206 with the goal of optimizing advertisers 206's spending and placing monetary values on displaying advertising of a particular format, on a particular website, to a particular audience. In an embodiment, advertiser broker 208 maintains a user interface through which it interacts with advertisers 206, and through which it manages advertisers 206's preferences, such as preferences for particular user data attributes. However, embodiments of the present invention are not limited to any particular advertiser preferences.

In an embodiment, an advertiser sets up ads in the advertiser broker system, but has no further interaction with the exchange (see below) or end user until such a point as the end user clicks on their ad. This means that the advertiser does not see any user attributes that have been populated by audience data brokers (see below) as part of the exchange transaction. In an embodiment, the exchange (see below) carries enough information to allow for advertisers to setup self-optimizing campaigns based only on landing URLs, creatives, and campaign goals. Similarly, algorithms can be run on advertiser landing URLs to choose possible subsets of audience attributes as well as relevant topics (keywords, categories, and content pages). The available features can then be selected to maximize the campaign goals, for example branding campaigns would minimize the amount paid per impression and maximize the coverage and inventory quality. A sales campaign on the other hand would be selected to track conversions and maximize the number of high value conversions for the existing advertiser budget.

Architecture 200 also comprises audience data broker 210. For purposes of explanation only, only one audience data broker will be discussed herein. However, embodiments of the present invention are not limited to a single audience data broker, as any number of audience data brokers may exist. In an embodiment, audience data broker 210 is an aggregator of user data providers. A user data provider is any entity that maintains any partial information that can be referred back to an individual user (such as one of users 214, discussed below) for advertising purposes.

Publishers may be interested in the audience information, independently of the advertisers on the advertising exchange. For example, a publisher may want to show different content on their web site to users based on the gender of the users, e.g., to attract more people to the site. In this regard, the publisher may be interested in buying audience information for presentation purposes, independently of the advertisers in the exchange. Thus, both advertisers and publishers participating in an advertising exchange are interested in audience information.

User data, for example, may comprise demographic, psychographic, and behavioral information. More specifically, for example, user data may comprise age, gender, wealth index, interests, shopping habits, etc. However, embodiments of the present invention are not limited to any specific type of user data. In an embodiment, audience data broker 210 is any large user data aggregator, such as PayPal, Visa, Yahoo!, Verizon, as well as an aggregate of smaller user data providers. Any online store that collects user data can function as audience data broker 210 by providing user location level and user purchase pattern level information. This information can be aggregated with demographic profiles from small web email providers to form more comprehensive user descriptions.

In an embodiment, audience data broker 210 enriches information regarding a user viewing one of publishers 202's web pages. In an embodiment, audience data broker 210 does not disclose any personally identifiable information about the user. In an embodiment, audience data broker 210 accomplishes this by performing a private user ID lookup and passing back a set of aggregate user attributes that could be consumed by advertisers 206 and advertiser broker 208. This user attribute enrichment increases the value of the display of the ad to advertisers 206, helps produce more relevant ads to consumers, and creates a more complete picture of the user for ad serving purposes without violating the user's privacy. The aggregation across different providers serves two independent roles, in an embodiment: (1) it creates a comprehensive view of the audience landscape, and (2) it thickens the data sources to allow for anonymization and preservation of user privacy.

In an embodiment, audience data broker 210 receives direct payment for even small and/or partial user attributes. By participating in architecture 200, audience data broker 210: (1) is paid for its information, (2) can enrich its information (even redundant data providers are useful for scoring purposes), and (3) can verify its information (providers with poor quality of data will gain insight and will be able to actively address data quality issues). In an embodiment, audience data broker 210 receives a request from publisher broker 204 proxied by exchange 212 (explained in greater detail below). Audience data broker 210 appends known user attributes into this request for the consumption of advertiser broker 208. Audience data broker 210 does not know the page that the user is on from publisher broker 204, and audience data broker 210 will not pass any user identifiers to advertiser broker 208.

In an embodiment, audience data broker 210 comprises a user data recorder to record user information into the exchange (discussed below) and a user data delivery system to respond to requests for the user information. In an embodiment, the user data recorder informs the exchange that the audience data broker knows something about a user, through whatever means that may be. To do this, when the audience data broker has contact with a user that they know something about, the audience data broker can either set up a single pixel gif call to the exchange that the user will perform, or the audience data broker can redirect the current user request to the exchange, along with the information and a destination URL for the exchange to redirect the user to afterwards. In each case, whatever information or data key the audience data broker wishes to receive back is expected to be enough so that the audience data broker can answer user data delivery system requests for the use. In an embodiment, the information passed to the exchange is signed in a manner that proves the identity of the audience data broker to the exchange. In an embodiment, the exchange, upon verifying the identity of the audience data broker, will set a cookie to the user's browser with the name of the cookie identifying the audience data broker, and the cookie value being the information provided. In an embodiment, when the exchange receives an ad request from a user (the user having been sent to the exchange from a publisher broker), if there are any user data attributes that the publisher is willing to pay an additional amount for, then the cookies for all audience data brokers are read from the user's browser. For each audience data broker identified by a cookie, if the audience data broker is currently live, the exchange will send a request to that audience broker with the cookie value and any unknown data attributes which the publisher is willing to pay to have provided. The audience data broker then responds back, including the information for as many attributes as they know, along with the price they are asking for to allow it to be used.

In an embodiment, audience data brokers can participate in an advertiser auction and get paid directly through an advertiser bid with no audience data requests from the publisher broker. This would be considered a “publisher blind” audience data delivery. If an advertisement bid meets and exceeds a publisher requested minimum, then the bid remainder left after publisher ask can be used to acquire user data and maximize advertiser ROI (return on investment) using tighter targeting. The exchange provides a call back to the winning audience data broker(s) letting them know what attributes they won on, and what amount they will be paid for that information.

For the avoidance of doubt, exemplary embodiments herein describe an audience broker in the context of advertisers benefiting from the audience information output by the audience broker, however, as noted earlier, publishers also benefit from audience information. For instance, in addition to other utility functions or biases expressed by a publisher to an online advertising exchange in accordance with the invention, the publisher's utility function might be expressed as a function of a specific user. For example, a publisher might want all the advertisements to be “age appropriate” for the users of the publisher's site.

Given that publishers and advertisers can apply payments directly to audience data brokers for specific information, in an embodiment, there is a verification and rating process for audience data brokers. Multiple audience data brokers will be competing for the same service. In an embodiment, competition is performed based on ask, but also based on quality of data. Advertisers will have transparency into the publisher broker network, and similar transparency can be offered into the audience data broker network by offering a rating system. Audience data broker ratings can be calculated dynamically through the use of overlapping collection symbols. Overlapping data could be used to calculate ground truth predictions as well as verify the data provided by individual audience data brokers. This information in turn could be used to automatically rate audience data brokers. In an embodiment, a simple voting system can be used to verify the accuracy of any specific collection symbols for each broker, or the quality of the broker as a whole. The maintainers of the exchange would be responsible for publishing the voting consensus to the public, or to disbar the broker completely if necessary.

In an embodiment, no audience data broker will be able to provide ground truth data for all users. However, it might be possible to generate such data by creating data functions based on different providers and choosing the consensus opinion for each attribute. Publishers and advertisers could choose to use the consensus opinion or any individual audience data broker's collection symbols. In an embodiment, data units of “statistically significant” user data attributes could be created. Most audience data brokers often run into privacy issues not due to the data they have, but due to the data they don't know. Holes in a user profile could be significant or unique enough to be carrying sufficient information to reconstruct a unique user. Filling-in these holes using data from other user data providers could allow those providers to generate statistically significant aggregates that can be used for research purposes without sacrificing user privacy.

Architecture 200 also comprises exchange 212. Exchange 212 acts as a mediator among publisher broker 204, advertiser broker 208, and audience data broker 210. Exchange 212 is the framework that allows publisher broker 204 to have its ads enriched with additional user data by audience data broker 210. In an embodiment, exchange 212 routes traffic and facilitates transactions, e.g., auctions, between publisher broker 204, advertiser broker 208, and audience data broker 210. In an embodiment, exchange 212 is a server or a set of servers. Exchange 212 creates a system in which audience data broker 210 can monetize its data and in which advertiser broker 208 can reach a larger audience of more highly targetable traffic. In an embodiment, exchange 212 provides minimum standards of conformity, ensuring that some base information about the request is provided to be used by advertiser broker 208, regardless of population data from publisher broker 204 and audience data broker 210.

To provide minimum standards of conformity, in an embodiment, exchange 212 provides collection symbols related to the category of the publisher's page, the meaningful keywords in it, as well as geo-location information extracted from the user's IP address. The base data, such as the user IP address, the URL of the publisher's page, and any other such information deemed relevant should also be provided to each advertiser broker so that the advertiser broker may attempt to extract additional information to provide value-added services to the advertisers they service. In an embodiment, exchange 212 sends all publisher broker requests that match a set of criteria defined by the advertiser broker, along with all relevant data about the request (e.g., the ask and collection symbols provided by the publisher, audience broker, and the exchange itself). In an embodiment, if the advertiser broker has any ads that it would like to have displayed and that meet the ask, it returns those ads, up to the number of ads requested, along with a CPI (cost per impression) bid on each. It is noted that CPM (cost per thousand impressions) and CPI are equivalent pricing models with different acronyms. However, embodiments are not limited to CPI pricing, as other pricing models may be used, e.g., CPC (cost per click), CPA (cost per acquisition), and revenue sharing. Exchange 212 provides a call back to the winning advertiser broker(s) telling it which ads were displayed, and at what prices.

Architecture 200 also comprises users 214. For purposes of explanation only, only one user will be discussed herein. However, embodiments of the present invention are not limited to a single user, as any number of users may exist. Users 214 request a webpage from publishers 202. The webpage comprises content and advertisement space, which is filled with advertisement(s) from advertisers 206.

Using architecture 200, audience data can be provided to advertisers 206 either by enriching the publishing property with customer intelligence or by acquiring the data directly from audience data broker 210 on the basis of a licensing fee. Advertiser broker 208 can choose to pay an estimated monthly per volume amount for each attribute that their advertisers are interested in targeting. This transaction could be done off-line but would need to be registered with exchange 212 to facilitate data rerouting at request time. Advertiser broker 208 can base its bids on any targeting attributes provided by audience data broker 210. For example, advertisers 206 may place base bids either on a CPC or CPM basis and have the option to incrementally bid for any attribute values exposed to them. Advertiser broker 208 is free to pay higher rates for redundancy or higher data quality. Advertiser broker 208 may manage the risk surrounding assessing individual advertiser performance and converting all bid types to CPI for final ranking by exchange 212. In an embodiment, the pricing model is similar to the pricing models discussed above.

In an embodiment, when publishers 202 have an impression that they are willing to sell (with an optional ask), they can provide a URL and any targetable values to exchange 212. Exchange 212 passes this data and possible additional user data from audience data broker 210 to advertiser broker 208. In an embodiment, advertiser broker 208 ranks the bids of advertisers 206 using any proprietary attributes or techniques that it finds useful. For example, advertiser broker 208 could choose to run keyword extraction or categorization and use this for targeting. Advertiser broker 208 would output a CPI ranked list of advertisers (in an embodiment, the number would be equal to the number of ads requested by the publisher), where the CPI value would already be stripped of any costs used for purchasing audience data. In an embodiment, where multiple advertiser brokers exist, exchange 212 then ranks all ads across all advertiser brokers and chooses the best one (as measured by CPI). If these ads meet or exceed the publisher ask, then exchange 212 proxies a display of the ads on the publisher website.

A second-price auction can still be applied to facilitate aggressive bidding. Publishers 202 can get paid on a CPI basis. Ad impressions are logged to be used for traffic volume calculations used for audience data licensing. In an embodiment, exchange 212 may be used to gate user information originating from publishers 202. Publishers 202 can choose to enrich their property with user data and share this information only with selected advertiser brokers.

To facilitate participants of all types to become part of architecture 200, it may be desirable to establish a pricing model that is extremely flexible, yet at the same time does not change the industry paradigm so greatly as to create confusion that would prevent potential participants from joining architecture 200. Advertisers are already accustomed to both CPC and CPM pricing, with a small but increasing market for CPA (cost per acquisition) pricing. Publishers tend to prefer CPM pricing, and the larger, more complex publishers sell traffic broken down by user demographics and in other ways. Smaller publishers generally have to accept what they can get, which often results in CPC or CPA pricing. Profile owners, such as audience data brokers, have not typically been able to capitalize on their data, and when they have, have done so in flat transactions for aggregate data.

To support the flexibility of all of these pricing models, and even to allow for others in the future, in an embodiment, exchange 212 is based on a CPI model between publisher broker 204 and advertiser broker 208, where, on each request, publisher broker 204 will set a minimum ask, i.e., reserve price, for their available ad space, and advertiser broker 208 will place a bid on the right to have their ads displayed on this request. As discussed above, embodiments are not limited to CPI pricing only. Exchange 212 will take a small portion of the revenue flowing through it to support its operations, which can either be implemented via incrementing the publisher ask by some percentage, or by making agreements with publishers 202 that some percentage of the revenue generated from their traffic will be held back.

Because publishers 202 are concerned with user satisfaction, they would prefer to have some control over the relevancy of the ads placed on their site. Click-through rate is considered a good measure of relevance and therefore many publishers might want minimum click-through guarantees on the ads. Exchange 212 allows publishers 202 to optionally specify a minimum click-through rate that is acceptable. Exchange 212 monitors advertiser broker 208 to make sure that if it wins these types of asks, then it is meeting the performance guarantees. In an embodiment, if an advertiser broker consistently provides low click-through rates for publisher asks that require a minimum, exchange 212 may take punitive measures such as suspension from the system.

Advertiser broker 208 is responsible for converting any externally facing pricing models it allows into the CPI bid on each request. For example, a simple CPC to CPI conversion would be to multiply the per click bid of each ad by the expected click through rate of the ad for the conditions present. Similarly, to convert a CPA bid to CPI, advertiser broker 208 could multiply the conversion rate by the per conversion bid of the advertiser. The more information available in each request, the better job advertiser broker 208 can potentially do in predicting the probability of a click or a conversion. Since it is expected that advertiser broker 208 will therefore desire additional information along with each request to help it predict what those probabilities are, as well as to allow the advertiser to express a preference for one or another of those attribute values by bidding differently, they will want to have information from audience data broker 210 at request time. The pricing model between audience data broker 210 and advertiser broker 208 will be a market, where audience data broker 210 sets minimum guarantee asks, as well as CPM pricing rates. In an embodiment, advertiser broker 208, if it wishes to use audience data broker 210's information, will agree to pay the greater of the guarantee amount or the CPM rate for the number of ad impression auctions that it wins. Exchange 212 is necessary to this transaction so as to track the number of ad impression auctions advertiser broker 208 wins, as well as to query for an attach audience data broker 210's user information to the request sent to advertiser broker 208.

The entity hosting exchange 212 has access to all data sources, giving it the power to make partial decisions. To alleviate the concern that exchange 212 will not be impartial both as hosting body and as a direct participant, in an embodiment, transparency will be built into exchange 212. In that embodiment, exchange 212 does not have a way to identify brokers of any kind. Also, in that embodiment, advertiser auction algorithms and advertiser to publisher and audience data broker matching algorithms are standardized and transparent to all exchange participants. In an embodiment, no user identifiable information is sent to advertisers 206 until the user performs an action. Exchange 212 passes advertiser broker 208 only the attribute values. Advertisers 206 do not see the user identifier. At click-time, however, it is still possible for an advertiser to establish a user identifier and associate the bidding profile with that user. By participating in architecture 200, audience data broker 210 is explicitly sharing its information with advertiser broker 208. Although some leakage is inevitable whenever targeting is permitted (e.g., if a user is targeted and clicks on an ad, the advertiser can correlate and store the targeting attributes for that user), providing audience data from every ask to advertiser broker 208 for bidding purposes exacerbates the problem. However, this can be addressed by centralizing the auction system at the exchange level by requiring that advertiser broker 208 specifies a value function that is evaluated for each ask on exchange 212. For example, exchange 212 could require a linear value function, and advertisers 206 would specify a base bid and a bid increment for each attribute value. Exchange 212 would control the instantiation of the audience data, thus not leaking any to advertiser broker 208. The exchange can also support “opt-out” for users to mitigate privacy concerns. In other words, a user can specify that the user does not want any of the user's information used in the exchange.

In one example, Expedia as an advertiser has an ad for “cheap vacations in Bali.” Expedia chooses the keyword “Bali vacations.” Business intelligence suggests that the best way to target vacation ads is around users who have a history of purchasing vacations, users who recently have purchased books on vacations and users who perform searches related to travel. Expedia decides to license user information from Amazon, MSNSearch, and Orbitz. Expedia agrees to pay Amazon 1 cent for using their user information for each ad impression. Similarly, Expedia agrees to pay 1 cent to MSNSearch and 3 cents to Orbitz.

For the “cheap Bali vacations” ad, Expedia creates a targeting profile for users who: “bought a book on Bali in the last month,” “Have traveled to a tropical location in the last two years,” “Have household income between $30,000 and $60,000,” “Have been searching for vacation deals,” and “Have ever clicked on ads.” Expedia places a 20 cent base bid. To express their bidding preference, they also place a 5 cent incremental bid for the first attribute, a 10 cent incremental bid for the second attribute, a 2 cent incremental bid for the third attribute, 1 cent incremental bid for the fourth attribute, and a 2 cent incremental bid for the fifth attribute to express their bidding preference. Additionally, exchange 212 will log all views where user data was used to enrich targeting and help audience data broker 210 enforce the licensing fees. Borders as a publisher has a user requesting the page on the “Lonely Planet Guide to Indonesia” and they would like to show ads on that page. They call exchange 212 with the page URL and information about the user: “Bought four travel books in the last month,” “Bought a book on Bali in the last month,” and “Has clicked on ads before.”

Given the URL, exchange 212 extracts keywords (“Bali vacations,” “Indonesia travel,” “exotic vacations,” “beach vacations”), categories (“travel,” “vacations”) and proxied user data information (coming from the licenses with audience data broker 210), and sends this information to each advertiser broker. Each advertiser runs an auction for the impression. The advertiser broker can choose to ask for aggregate bids from advertisers and subtract the audience data broker licensing fees at the time of the impression. For example, Expedia might place an aggregate bid of 24 cents, and after subtracting the licensing fees, their base bid would be equal to 20 cents. Expedia's advertiser broker needs first to subtract all incremental bids and to assign credit to the publisher or audience data broker as appropriate. For example, Expedia's 5 cent incremental bid for “bought a book on Bali in the last month” and their 2 cent incremental bid for “Have ever clicked on ads” will be assigned to the publisher. The value for “Have traveled to a tropical location in the last two years” attribute is provided by Orbitz so the 10 cent incremental bit would be assigned to them. Neither the publisher, nor the audience data brokers were able to assess the household income of the user so this incremental bid is not used. The 1 cent incremental bid for the search user patterns will be credited to MSNSearch. After the appropriate credit distribution the advertiser broker would assign a publisher value bid (the base bid+any incremental publisher bids) to each advertiser. In case of Expedia publisher value bid would be equal to 27 cents. Given that Expedia's bid is CPC based, the advertiser broker needs to convert it to a CPI one before running an auction and selecting the best ads to send to the exchange. Expedia's advertiser broker knows that this specific ad is likely to get a 10% CTR, and thus for ranking purposes, Expedia is assigned a 2.7 cent CPI bid. If Expedia wins within its advertiser broker, its ad will be sent for global ranking to the exchange. If Expedia wins the global auction then their advertiser broker is charged 2.7 cents for displaying the Expedia ad. Expedia's ad gets served on Border's page. The user clicks on the ad. The user buys a two-week vacation to Bali.

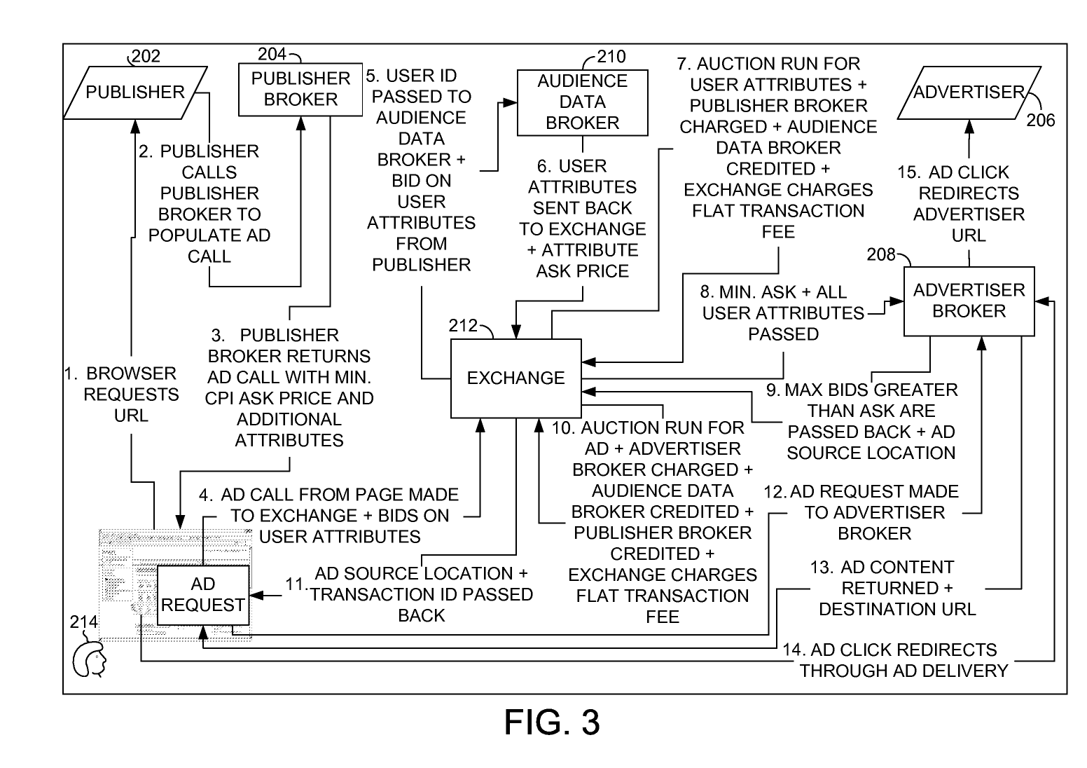

FIG. 3 illustrates one example of the flow of data within architecture 200, according to embodiments of the present invention. Referring to FIG. 3, user 214 opens a browser and requests a URL of a webpage from publisher 202 (1). In an embodiment, the webpage has some advertisement space available, which publisher 202 desires to sell to an advertiser. Publisher 202 calls publisher broker 204 to populate the ad call (2). Publisher broker 204 returns the ad call with a minimum CPI ask price and additional attributes (as discussed in greater detail above) (3). The ad call is made to exchange 212 along with bids on user attributes and a user identifier (4). Exchange 212 passes the user identifier and the bid on attributes to audience data broker 210 (5). In an embodiment, audience data broker identifiers are stored on the user-side and are sent with the ad call to exchange 212 so that exchange 212 can identify which audience data broker(s) may have information about the user. Audience data broker 210 looks up the user identifier and responds with the corresponding attributes along with an attribute ask price (6). In an embodiment, exchange 212 runs an auction for the user attributes, charges publisher broker 204, credits audience data broker 210, and holds back a flat transaction fee (7). Exchange 212 passes a minimum ask plus all user attributes to advertiser broker 208 (8). Advertiser broker 208 responds with all of the bids that are greater than the ask, along with the ad source location (9). In an embodiment, exchange 212 runs an auction for the ad, charges advertiser broker 208, credits audience data broker 210 and publisher broker 204, and holds back a flat transaction fee (10). Exchange 212 passes the ad source location and transaction identifier back (11). An ad request is made to advertiser broker 208 (12), which responds with the ad content and a destination URL (13). If user 214 clicks on the ad, the user is redirected by advertiser broker 208 (14) to advertiser 206 (15). The above example illustrates just one embodiment of the present invention. Other embodiments may not involve the same operations or conduct them in the same order. Specifically, other examples may not supplement with data from audience data broker 210. Other examples may not rely on auctions to set prices, instead relying on a firm ask that can be accepted or declined.

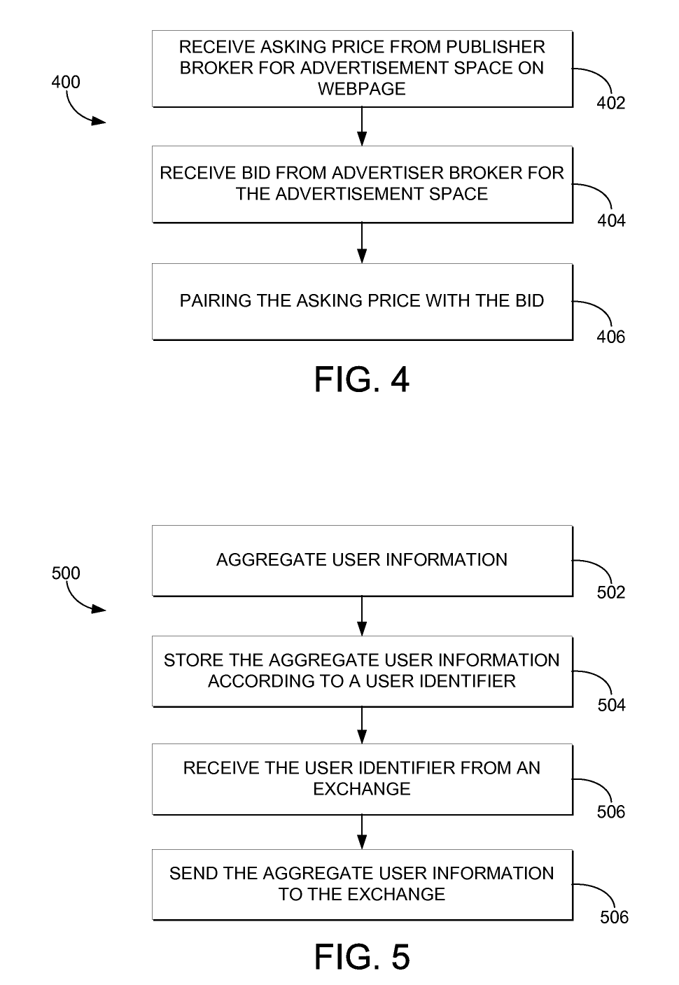

FIG. 4 illustrates a flowchart of the operation of an exchange, according to embodiments of the present invention. Referring to FIG. 4, method 400 begins with the receipt of an ask from a publisher broker for advertisement space on a webpage (402). A bid is received from an advertiser broker for the advertisement space (404). In an embodiment, bids are received from many different advertiser brokers. The ask is paired with one of the bids (406) and the advertisement space on the webpage is awarded to the winning bidder. As discussed in greater detail above, other information such as user attributes may be attached to the ask, and quality of the bidding advertisers may be examined prior to the advertisement space being awarded.

FIG. 5 illustrates a flowchart of the operation of an audience data broker, according to embodiments of the present invention. Referring to FIG. 5, method 500 begins with the aggregation of user information (502). The aggregate user information is stored according to a user identifier (504). When the user identifier is received from an exchange (506), the aggregate user information corresponding to that user identifier is sent to the exchange (508). In an embodiment, the audience data broker may set a cookie on the user computer to identify itself as having information about that user. When the exchange reads that cookie, it knows which audience data brokers to query for information about the user.

Accordingly, in non-limiting embodiments, the invention includes a system to facilitate trading of advertising by having a publisher broker to represent publisher(s) that determines an ask for an advertisement space on the publisher(s)' webpages. An advertiser broker also represents advertiser(s) and manages an advertiser(s)' bid for the advertisement space. The exchange of the invention then facilitates transactions for advertisement space between the publisher broker and the advertiser broker.

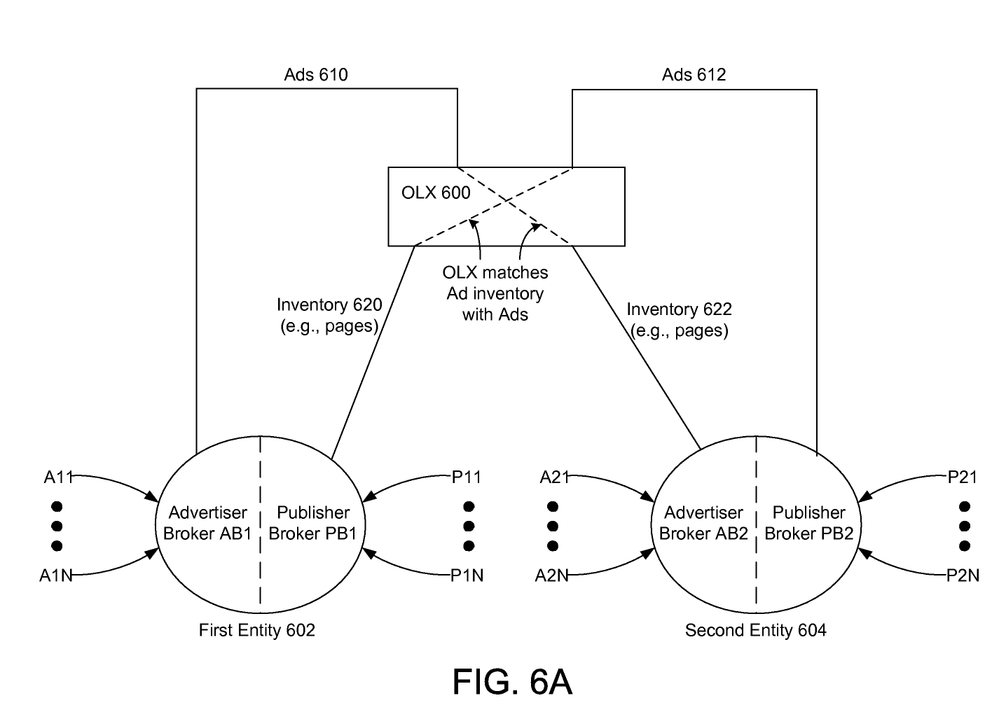

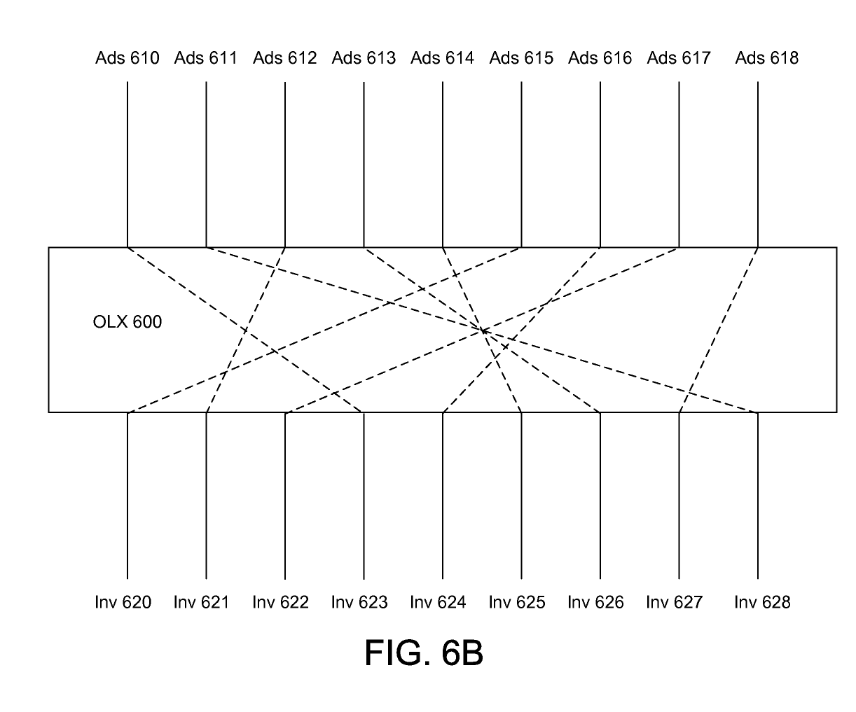

The invention thus can operate in a system that enables broad liquidity over distributed advertising markets, such as the above-described advertising exchange systems. FIG. 6A illustrates a conceptual block diagram of an on-line advertising exchange 600 provided in accordance with the invention. As shown, a first entity 602 and a second entity 604 are subscribers to the services of exchange 600. First entity 602 may have an advertiser broker AB1 for brokering advertisements 610 from a variety of sources A11 thru A1N and a publisher broker PB1 for brokering inventory 620 from a variety of publishers P11 thru P1N. A goal of ad broker AB1 is to find inventory for existing advertisements. A goal of publisher broker PB1 is to represent publishers, i.e., to help obtain revenue for their inventory (e.g., pages). Similarly, second entity 604 may have an advertiser broker AB2 for brokering advertisements 612 from a variety of sources A21 thru A2N and a publisher broker PB2 for brokering inventory 622 from a variety of publishers P21 thru P2N.

In accordance with the invention, by providing ads 610 and 612 to OLX 600 according to a first communications layer, and by providing inventory 620 and 622 to OLX 600 according to an independent communications layer, OLX 600 can efficiently match advertisements to available inventory with greater simultaneous knowledge of multiple advertising networks.

For instance, first entity 602 might be Microsoft's MSN Web site, and second entity 604 might be Yahoo's portal Web site. For simplicity, FIG. 6A illustrates only two entities, but advantageously, the invention can also be scaled to accommodate any number of advertising networks, e.g., eBay, Amazon, Google, etc. This is illustrated in FIG. 6B showing an OLX 600 that accommodates a wide range of advertising 610, 611, 612, 613, 614, 615, 616, 617, 618, etc. from a wide range of parties, and also accommodates a wide range of inventory 620, 621, 622, 623, 624, 625, 626, 627, 628, etc. from a wide range of parties. OLX 600 then makes the best assessment of how to match advertising content with inventory according to a variety of policies (e.g., maximizing ad revenue, maximizing quality of advertising, maximizing conversion rate, etc.). While various non-limiting embodiments of the invention are described in the context of two parties herein, this is for ease of conceptual presentation. It can be appreciated that the invention can be provided for any arbitrary number of advertising entities wishing to join the exchange 600.

Having thus described an exemplary advertising exchange environment, various non-limiting embodiments of the specification and normalization of utility functions for participants of an advertising exchange or advertising framework in accordance with the invention are now presented in more detail below.

### Specifying and Normalizing Participant Utility Functions

As mentioned, the invention enables each participant to a multi-party advertising exchange to specify one or more utility functions that are invertible with respect to a common measure, such as revenue, e.g., expected revenue per standard advertising unit. The disparate utility functions of multiple participants can be normalized within the advertising exchange by converting the utility functions to the common measure enabling the comparison or translation of a first set of utility functions to a second set of utility functions in quantifiable terms.

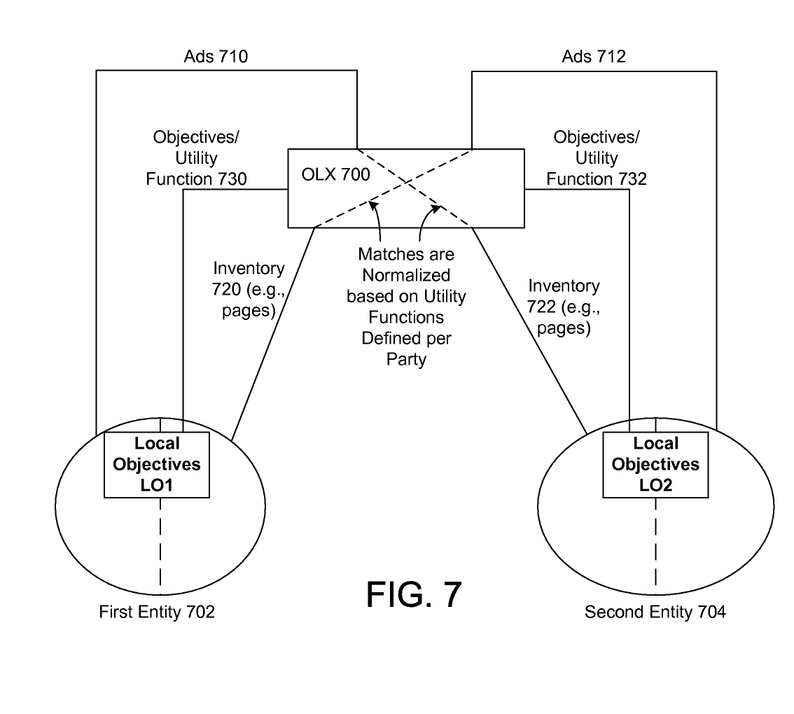

FIG. 7 illustrates an exemplary non-limiting embodiment of the invention that provides the ability to balance local party objectives with remote party objectives, in effect applying a tax under various circumstances as set by the parties. Each participant is provided with the ability to create and modify their objectives for input to the exchange 700. First entity 702 thus has a set of local objectives LO1 and second entity 704 has a set of local objectives LO2, which allow the entities 702 and 704 to fine tune their preferences with respect to participation in the exchange 700 of advertising 710, 712 and inventory 720, 722 in accordance with the invention. Receiving local objectives LO1 and local objectives LO2, exchange 700 automatically operates to “tax” certain transactions based on a comparison of objectives. This operates to balance the local objectives with the remote objectives so that all parties are satisfied with the quality of an advertising transaction based on pre-specified objectives or criteria, translating to a tax on the price of advertising in one direction or another, buyer or seller. The exchange 700 thus, in effect, provides a taxation method to balance local objectives with remote objectives.

For instance, a concrete example of the operation of such a taxation method would be if Yahoo, as first entity 702 with publisher space, says, “we don't want to publish ads that are of low conversion rate (a proxy for low quality).” By defining this objective in local objectives LO1, this information is taken into account by exchange 700 so that if an advertiser with ads having a low conversion rate purchases the inventory, a “bad quality” tax (e.g., 25%) is added to the purchase price to encourage, in a free market sense, more quality advertisers to purchase inventory, or inversely speaking, to discourage low quality advertisers from purchasing inventory without paying a premium on price. Conceptually, each party thus has “knobs” to fine tune the way its inventory or advertisements are handled by exchange 700, which in turn communicates an effective tax rate to the parties so that rational decisions can be made about the transaction.

Related to the notion of balancing local objectives is the notion that some transactions may create an instability, and in such circumstances, exchange 700, as an intermediary with knowledge of both buyer demand and seller supply, can operate to place roadblocks around certain transactional conditions to preserve overall stability of the market. For instance, where inventory, or supply, otherwise becomes limited, exchange 700 might operate to prevent bulk transaction purchasing to prevent overbuying where there is no supply. More generally, where a condition exists that may cause collapse of an advertising market, exchange 700 can operate to intervene to prevent further instability or collapse. In this respect, the local objectives definable by each participant can also impact whether roadblocks are applied for any given transaction under any particular set of circumstances.

As mentioned, in exemplary, non-limiting embodiments, the distributed framework for online advertising of the invention enables the specification of personal or private utility functions, i.e., each party can specify respective maximization functions for transactions in the advertising exchange based on different utility functions. Since each party has unique business goals and objectives, a wide variety of objectives may be toggled, or modified in accordance with the invention to specify party utility functions on a per party basis. For instance, as publisher broker, a typical goal is to maximize revenue for the available advertising inventory. But for another publisher broker connected to the exchange, the publisher broker might have 10 ads, but wish to emphasize only 1 particular ad for relevance. Yet another publisher broker might wish to only display “name brand” advertisements, i.e., no advertisements from relatively unknown “mom+pop” establishments, or other small concerns. And so on.

Once each party has specified a complete utility function which maps to the goals and objectives of the party with respect to advertising, this information is received by the exchange. Since initially, different parties' utility functions may be specified according to different vocabularies, the exchange operates to normalize all of the utility functions of the different parties into a common currency. For instance, with respect to advertising, utility functions have typically been defined with respect to such metrics as cost per impression (CPI), cost per click (CPC) or cost per acquisition (CPA), also sometimes called cost per conversion. Any party can specify a utility function based on any of these metrics, and based on known mappings between metrics, utility functions across different parties can be normalized. For instance, the CPC metric can be converted to the CPI metric, and vice versa, according to the following relation:

CPC=CPI*Probability of Click (e.g., Clickthrough Rate)

And the CPA metric can be converted to the CPC metric, and vice versa, according to the following relation:

CPA=CPC*Probability of Action Given a Click

In this regard, the probability of action is conditioned on the occurrence of a click. And by substitution, the CPA metric can be converted to the CPI metric, and vice versa, according to the following relation:

CPA=CPI*Probability of Click*Probability of Action Given a Click

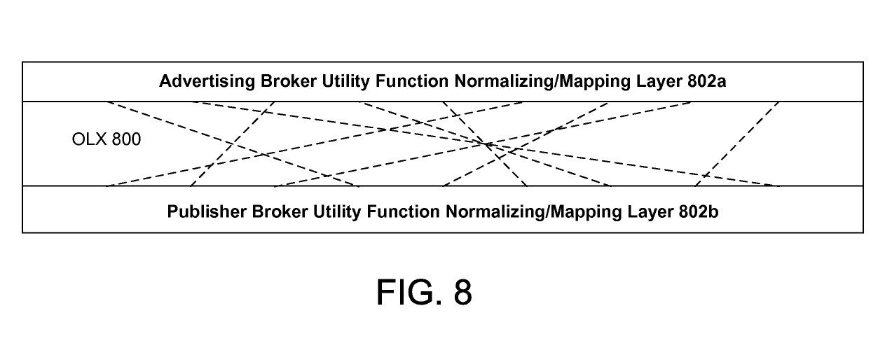

Arbitrary metrics, i.e., based on arbitrary variables other than impressions, conversions or acquisitions, can also be defined, and mapped to a common currency by the exchange. This is illustrated conceptually by exchange 800 depicted in FIG. 8. As shown, for utility functions defined for advertising brokers, a mapping/normalizing layer is shown as a first layer 802a before matching content takes place in order to normalize private utility functions defined across parties. In addition, another layer 802b normalizes utility functions defined by publisher brokers. Once normalization occurs in layers 802a and 802b to compensate for the individual preferences of the participants, exchange 800 operates as described elsewhere herein to match supply of advertising inventory to demand by advertisers for the inventory based on a common advertising currency. In one embodiment, the normalization process is made blind to the identity of the parties' involved in order to ensure a fair and objective normalization of utility functions.

In addition, in order to specify personal utility functions, the invention provides tools that allow entities participating in the exchange to explicitly state their personal utility function. For instance, a florist may sell roses, which have high margins, and carnations, which have low margins. When determining which kinds of keywords to buy, normally, the florist might be interested in 3 different keywords including “flower,” which might be inexpensive due to its widespread applicability, “rose,” which might be expensive due to its high margin target, and “carnation,” which might less expensive because of lower margins. Accordingly, based on anticipated returns, a party might specify a utility function that would select only high margin keywords, e.g., “rose”, as a keyword. For another example, a participant might specify a utility function as a probability of expected clickthrough rate with respect to keywords, in which case a different set of keywords might be optimal.

In this regard, the number of factors that a user can vary with the tools of the present invention to personalize a utility function for advertising are virtually limitless. Also, the factors can be tailored to advertising segments, i.e., banner ads can have different factors for personalization than keywords, which have different facts for personalization than pop-up ads, and so on. Furthermore, rather than require an explicit mathematically defined utility function, the tools of the invention optionally express utility function factors in terms of business goals, e.g., maximizing revenue, preserving brand name, broadest advertising exposure, most socially responsible advertising exposure, most demographically targeted advertising exposure, policies based on clickthrough/impression/conversion/acquisition probabilities, and the like.

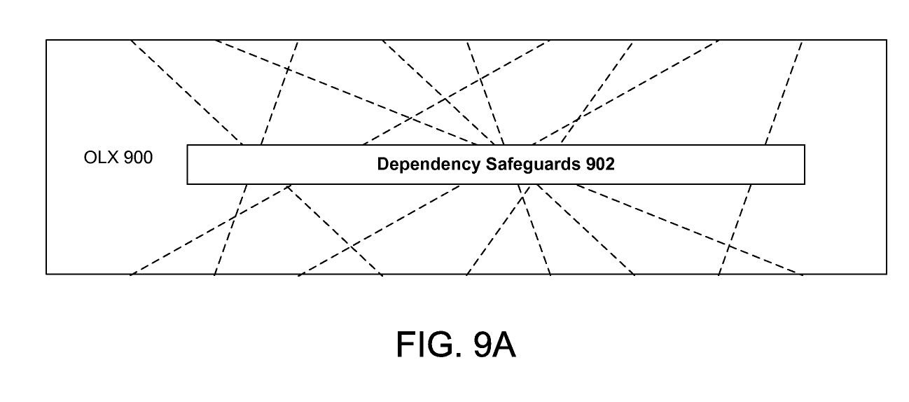

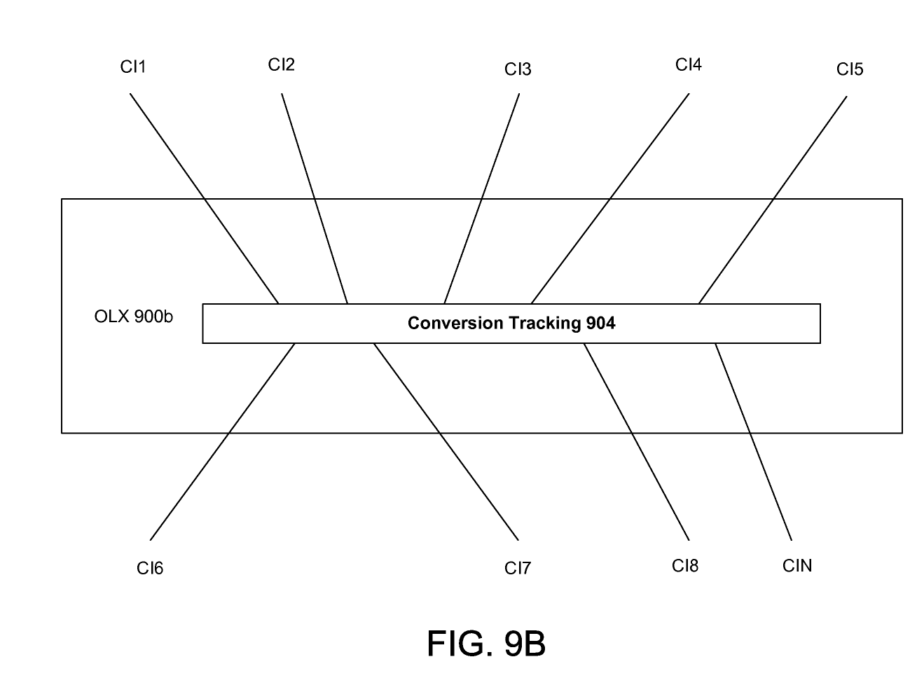

In other embodiments, as shown in FIG. 9A, an exchange 900 of the invention may be provisioned with dependency safeguards 902, which operate to protect against proscribed advertising auction conditions. For instance, based on the state of an auction, dependency safeguards 902 may operate to stop accepting bids under certain circumstances, e.g., safeguards 902 may operate to automatically turn off bidding for certain inventory when inventory runs dry. Accordingly, safeguards 902 act as an additional protective layer against exchange 900 acting in a manner inconsistent with available supply or demand during an auction. In addition, exchange 900 can operate to dynamically optimize which safeguards are applied and when. For instance, a variety of factors relating to time, world events, cost, geography, resources, etc., i.e., anything that may impact a real world transaction can be taken as input that serves to dynamically optimize the operation of safeguards 902.

In yet another embodiment, performance tracking is enabled to track performance information of participants to in an advertising exchange to reduce the variance in the expected utility of transactions. Thus, given a general utility function, the exchange can provide information that will reduce the variance in expected utility for the advertisers with that utility function.

Accordingly, in further embodiments of the invention, performance tracking whereby an advertising exchange collects and provides information that lowers the variance in the expected utilities for transactions conducted within the exchange.) Where performance tracking is enabled for the exchange of the invention, participants are provided with a more solid understanding of the performance for advertising and inventory because the information is provided across advertising networks and across different parties.

For example, one example of performance information is conversion rate information. In this regard, it is known that by increasing one's conversion rate for advertising, a marketer can lower the cost per acquisition without changing the cost paid for traffic. Even a small increase in conversion rate can have a dramatic profit impact, and so it is desirable to find publishing space with a high expected conversion rate. With conversion tracking provided in the distributed framework for online advertising in accordance with the invention, pricing can be made more accurate because conversion information is available across parties, averaging out individual transactional biases within any specific advertising network.

As mentioned, due to the federated nature of the exchange of the invention, performance tracking across different advertising networks can be achieved for a more holistic view of conversion rates for different advertising products. As shown by the online advertising exchange (OLX) 900b of FIG. 9B, the invention thus includes the ability to aggregate performance information from disparate sources, e.g., any of conversion information PI1, PI2, PI3, PI4, PI5, PI6, PI7, PI8, . . . , PIN. By collecting various types of performance information via a common tracking component, a real-time accurate view is enabled over the performance of all participants across the exchange, enabling all participants the opportunity to obtain their expected utility from advertising transactions.

In one embodiment, a modifier is specified as a discount rate, i.e., if a publisher is known to have a bad performance, e.g., bad conversion rate, for hosted advertisements, the publisher's inventory can be discounted in a way that is proportional to the modifier. As the publisher's performance becomes better and better, the modifier improves for the publisher, i.e., the exchange dynamically prices that publisher's space at a higher premium to recognize the improvement in performance. Similarly, if a publisher's performance begins to fall, the exchange of the invention will dynamically lower the price for that publisher's inventory.

Initially, not a lot will be known about the performance of an unknown publisher, or the quality of advertisements from an unknown advertiser. In this respect, in various non-limiting embodiments of the invention, the exchange in effect penalizes the lack of information available about performance until more information is provided or becomes available. In this respect, the exchange of the invention can operate as an independent referral or validating source for quality advertising spaces by pricing inventory with high performance at a standard rate (e.g., 20%) higher than inventory with no known performance history. Clickthrough rate, for instance, has been used historically as a measure of publisher quality, although other metrics may be assumed as well. Tracking publisher CTRs for advertisers bidding CPC provides useful information that is tracked for participants to reduce risk relative to expected utility. As another example, if an advertiser is interested in CPC bidding (CPM bidding, revenue share), the exchange can provide CTRs (number of impressions, revenue generated) for the various publishers.

Similarly, on the advertising side, an advertiser can be penalized by applying the modifier as a discount rate for having low quality advertising relative to other advertisers. Also, if an advertiser is running a totally unknown ad, the advertiser can be effectively penalized for being of “unknown” quality until the advertiser or advertisement, as it may be, has established information about the quality of the advertisements to the exchange.

For a concrete example of how this might apply, as any casual browser of the Internet has observed, mortgage brokers generate a lot of advertisements across a lot of different advertising spaces. As a result, the user experience around mortgage advertising is low, and the ads tend to be of poor quality, of low relevance and annoy users of the publisher's web site as a result. Accordingly, the exchange of the invention may apply a discount rate to mortgage advertisers that is commensurate with the low quality of their ads. In addition, the quality of the advertiser broker can be taken into account as well. By applying a discount function, such as F(quality of advertiser, quality of advertiser broker), the quality of the advertiser and/or broker can be taken into account when considering how to price a particular inventory given a candidate advertisement for match. In this respect, much like the Page rank algorithm rates Web sites in terms of endorsement, any proxy for reputation and quality of an advertiser can also be used when the exchange of the invention operates to match potential buyers and sellers of advertising space. Thus, in this particular example, due to a low quality score, a particular advertiser might have to pay more for a particular advertising space than another advertiser with high historical quality metrics.

Thus, in accordance with the invention, any measurement of performance, conversion rate, clickthrough rate, etc. as well as any measure of the quality level for advertisements can be taken into account by having the exchange of the invention apply a discount rate that accounts for bad conversion rate or lower quality by reducing the revenue realized by those spaces or ads, respectively.

In one embodiment, the invention applies a veil of secrecy to the names and identities of the participants in the exchange by applying aliases to the participants. In this regard, a participant's alias in the exchange hides their identity to other participants while at the same time allowing the exchange participant to share information about the past performance of certain kinds of advertising inventory. The exchange can also support “opt-out” for participants who do not wish to share their performance information with the exchange so as to guarantee the privacy of any participant who does not wish to share the competitive information. There may be other reasons a participant does not wish to share their information about their transactions with other participants in the exchange. Accordingly, a participant may optionally exclude itself from participation in sharing competitive information about its successes and failures in advertising transactions. In turn, other participants can optionally refuse to share competitive information with any participants who do not share with them.

As the above example regarding mortgage advertisements shows, chumming, i.e., the strategy of establishing a trail of scents and edible bits that leads one's quarry to one's boat, can effectively be applied for advertising spaces where it is difficult to target potential customers. Much like the fish in the sea, for such advertising products, it is unknown where the fish are at any given moment, but setting up a wide swath of entry points across a variety of advertising spaces acts to catch at least some fish from wherever they are. In this respect, there a lot of different on-line advertising practices that constitute effective advertising from the standpoint of the advertiser, but as a result of which the user suffers from an experience standpoint because the practices are annoying or non-friendly.

In one non-limiting implementation, a non-linear curve is adopted to weight the clickthrough rate as more important when matching advertisements to publishers by the exchange of the invention. While clickthrough rate has historically been used as a linear factor in pricing an advertising product, applying a non-linear curve based on clickthrough rate serves as a corrective market force, which penalizes the low quality “spam” advertisers, or conversely, reward advertisers that historically present advertisements with high clickthrough rates.

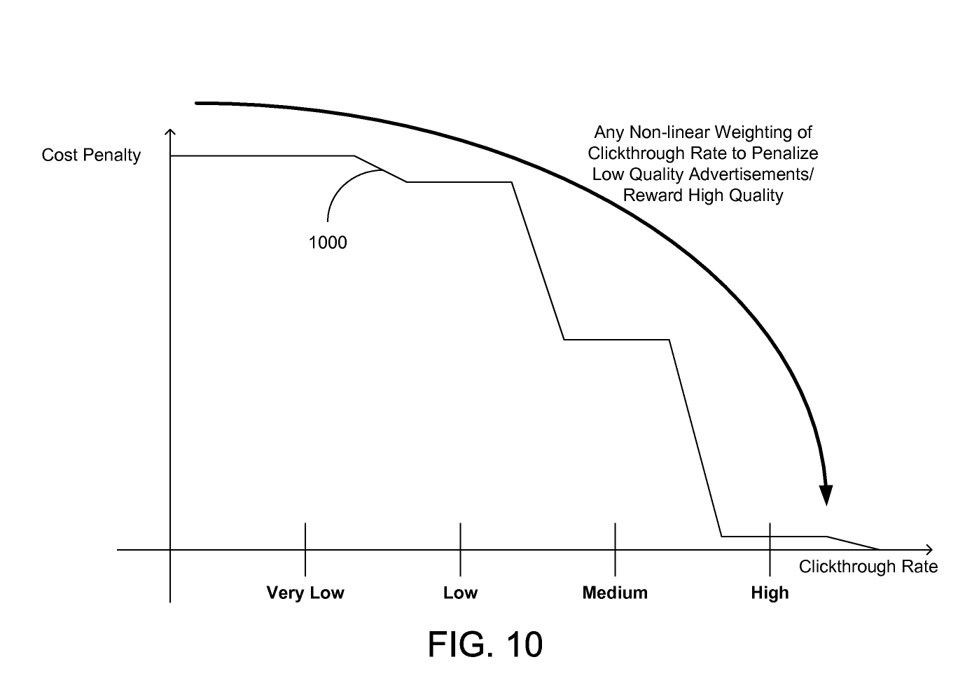

To elaborate, FIG. 10 shows an exemplary, non-limiting curve 1000 representing clickthrough rate for an advertising product on the X-axis varying non-linearly with cost penalty on the Y-axis. Whatever metric for quality is selected, e.g., clickthrough rate values or ranges, advertisers that have a very low or low quality score are assigned a high cost penalty. On the other hand, advertisers with demonstrated quality are assigned no or a very low cost penalty, or even an explicit positive reward (i.e., a cost discount rather than no cost penalty). In the middle, advertisers with medium quality are assigned some pre-specified cost penalty, but vastly reduced relative to the cost penalties of the very low or low quality advertisers. In this regard, any non-linear weighting scheme can be applied based on the quality of the advertiser in accordance with the invention, and as described earlier, such weighting scheme can be part of an entity's personal utility function since some publishers may be more averse to hosting spam advertisers than others.

FIG. 10 illustrates the non-linear weighting of clickthrough rates for advertising products. A similar non-linear weighting can be applied on the publisher side as well. As mentioned, conversion rate has been historically applied as a proxy for publisher quality, i.e., if in a given space, a high number of conversions result for advertisements posted there, this is behavior which is to be encouraged via the exchange when valuing the given inventory.

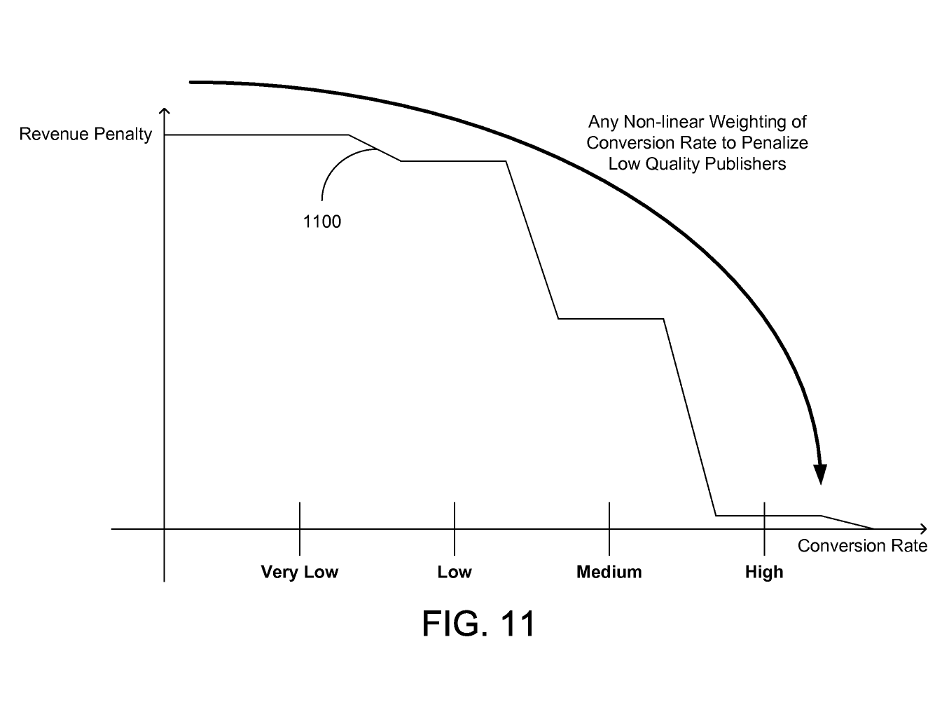

Thus, as shown by FIG. 11, an exemplary, non-limiting curve 1100 representing conversion rate for a publisher's inventory on the X-axis varying non-linearly with revenue penalty on the Y-axis. Whatever metric or proxy for conversion rate is selected, publishers that have a very low or low conversion rate are assigned a very high revenue penalty. On the other hand, publishers with demonstrated high conversion rates are assigned no or a very low revenue penalty, or even an explicit positive revenue reward (i.e., a revenue bonus). In the middle, publishers with mediocre conversion rates are assigned some revenue penalty, but vastly reduced relative to the revenue penalties of the publishers with very low or low conversion rates.

In this regard, any non-linear weighting scheme can be applied based on a proxy for conversion rate for publishers in accordance with the exchange of the invention, and as described earlier, such weighting scheme can be specified as part of an entity's personal utility function. Some advertisers, for instance, may wish to specify that they are particularly averse to (i.e., wish to penalize in a non-linear manner) advertising in spaces with low or very low conversion rates, or alternatively, wish to only advertise in spaces with high conversion rates, unless the price is imminently inexpensive. Such penalties on publisher inventory with low conversion rates operates as a lever on the free market forces that normally would apply to matching advertisements with inventory by the exchange of the invention. As a result, publishers have an additional incentive to keep content quality high in order to help avoid low conversion for ads coupled to the content, having a beneficial effect on the overall user experience of online advertising as encountered by most users.

In other exemplary non-limiting embodiments of the invention, temporal aspects that affect transactions matching advertisements with inventory are automatically taken into account. For instance, price curves can be applied over time to inventory so that certain inventory is priced properly in accordance with temporal events affecting the price. For instance, when the Super bowl is playing on television, or immediately following the game, advertising space on ESPN.com may be at a premium since it is likely that a high number of unique visitors will visit ESPN.com during the Super bowl or after. Accordingly, in various non-limiting embodiments, the exchange of the invention operates to normalize pricing for inventory based on temporal pricing variation.

For another example, if Golf.com has an advertisement run on television during the U.S. Open, which announces a deal on golf clubs that can only be redeemed by visiting Golf.com, then it is known that Golf.com will be a high trafficked property temporarily leading to a high conversion rate for other golfing advertisements (such as advertisements for a special on a Golf weekend in Myrtle Beach, etc.). In such example, the television advertisement is the temporal event that dynamically affects the pricing model applied by the exchange of the invention to the advertising inventory available at Golf.com. Accordingly, the exchange knows to temporarily weight the advertising inventory at Golf.com for a pre-defined amount of time following the television advertisement (or according to some other time varying pricing curve). The invention thus contemplates any weighting of pricing models for advertising and/or inventory based on a temporal factors that dynamically affect the value of a given transaction carried out by the advertising exchange of the invention.

In other exemplary, non-limiting embodiments of the invention, the exchange of the invention takes forecasting information as input when normalizing advertising currency across the available ads and inventory. Forecasting information includes any reliable metric for predicting a future price, and includes, but is not limited to, metrics for monitoring inventory supply and demand curves. In addition, as mentioned earlier, the exchange of the invention operates to normalize advertising currency as between a whole host of publisher brokers and advertiser brokers, and in doing so, creates a market for the exchange of advertising products, including futures market pricing. Forecasting information can thus be applied by the exchange of the invention when setting a price for online advertising futures as well.

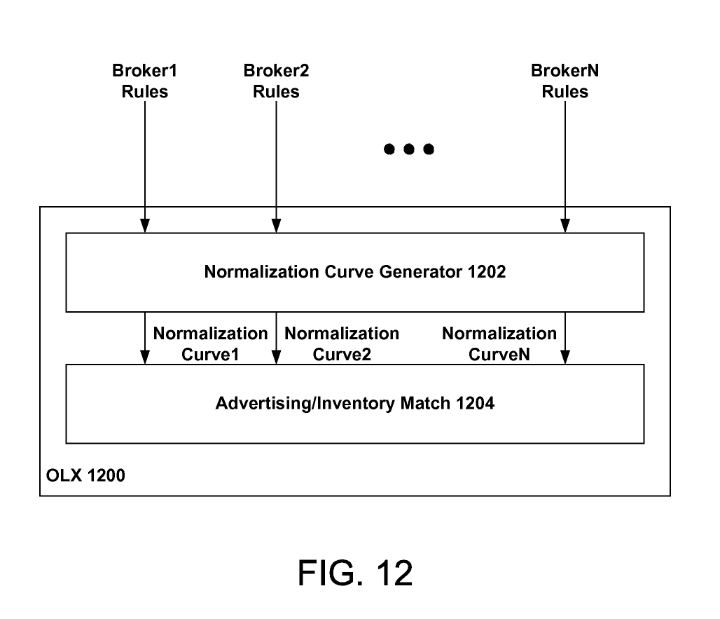

Since each publisher broker has different rules that apply to the pricing of inventory, in various non-limiting embodiments, the exchange of the invention generates normalization curves that apply across multiple brokers. In an exemplary embodiment, as shown in FIG. 12, broker1, broker2, . . . , brokerN submit rules for pricing, e.g., via a personal profile, which is received by normalization curve generator 1202 of OLX 1200. In this respect, normalization curve generator 1202 shields the advertising/inventory match process 1205 for determining how different rules interrelate. Normalization curve generator 1202 generates normalization curves Curve1, Curve2, . . . , CurveN, which are then used by advertising/inventory match 1204 to achieve a global currency exchange among all of its participants. In addition, since normalization curves are mathematical expressions of a broker's pricing rules, the invention operates to hide the biases expressed by any particular broker's rules from the advertising/inventory match process 1204.

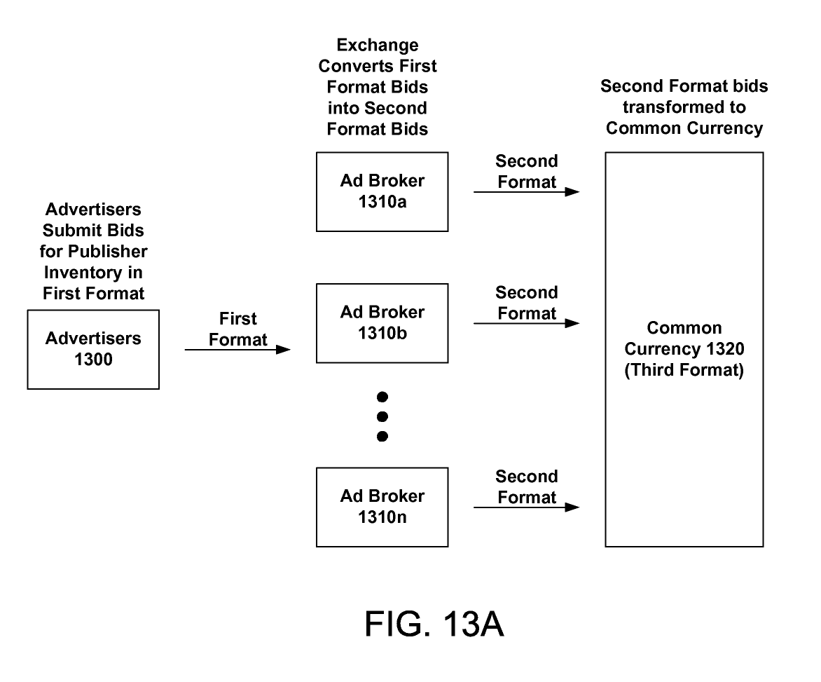

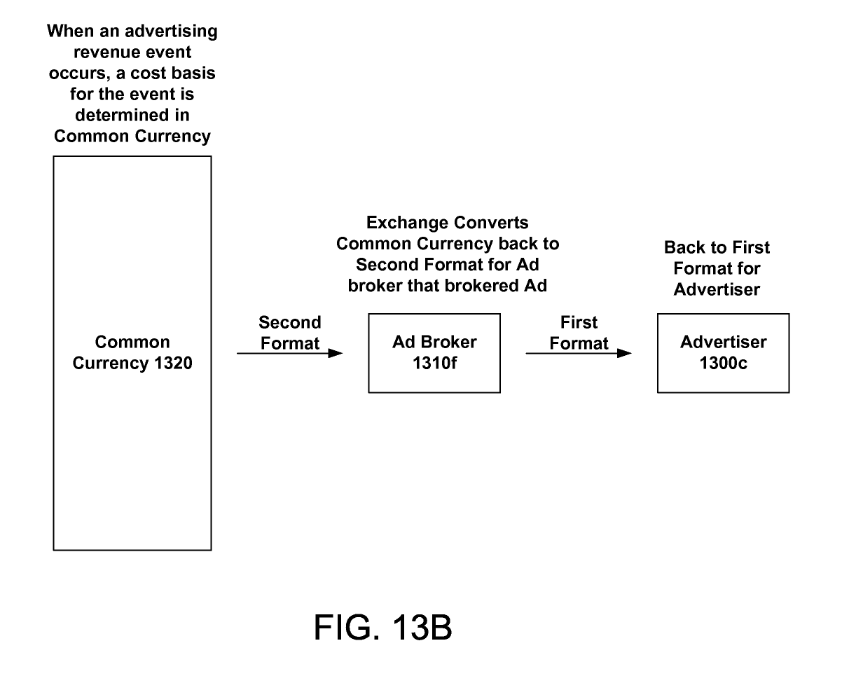

FIGS. 13A and 13B illustrate exemplary normalization of utility functions in accordance with the invention as between advertisers, advertising brokers, publishers and their brokers and the exchange that facilitates the normalization of disparate preferences. In accordance with the invention, any utility function can be defined on a per participant basis that maps back to a common measure for revenue, and by converting or inverting the utility functions with respect to revenue, a common currency ground can be defined so that the advertising exchange is grounded end to end by an expectation of fair value for all parties to an advertising transaction because a common measure is used despite disparate preferences and effective tax rates applied by different parties due to their preferences.

For instance, as shown in FIG. 13A, advertisers submit bids for publisher inventory in a first format including one or biases predicated on the nature of the advertiser. The exchange then converts the first format into a second format for any ad brokers 1310a, 1310b, . . . , 1310n that choose to broker the ad, which reflects a second format that is a preferable format for ad brokers. While a single second format is illustrated in FIG. 13A, each ad broker could have a different format based on varying utility functions between the ad brokers 1310a, 1310b, . . . , 1310n. Then, for further transaction in the exchange, the second format bids are transformed to a common currency 1320 that can be used in connection with transactions with publishers selling their inventory. As described above in connection with FIG. 12, the preferences and utility functions of publishers and publisher brokers can also be normalized to common exchange currency 1320 so that apples to apples revenue comparisons can be made.

FIG. 13B illustrates how the common currency 1320 can be used when an exemplary advertising revenue event or transaction occurs. For instance, when a monetization event occurs, a cost basis is determined by the exchange in the format of the common currency that applies to the monetization event. Then, the exchange converts the common currency back to the second format that applies to the particular ad broker, e.g., ad broker 1310f, that brokered the ad. Then, the exchange performs a conversion back to the first format for the particular advertiser who benefits from the event. Since each of the formats is invertible with respect to a common measure, expected revenue, the transaction is meaningful and comparable in terms of dollars across all of the parties.

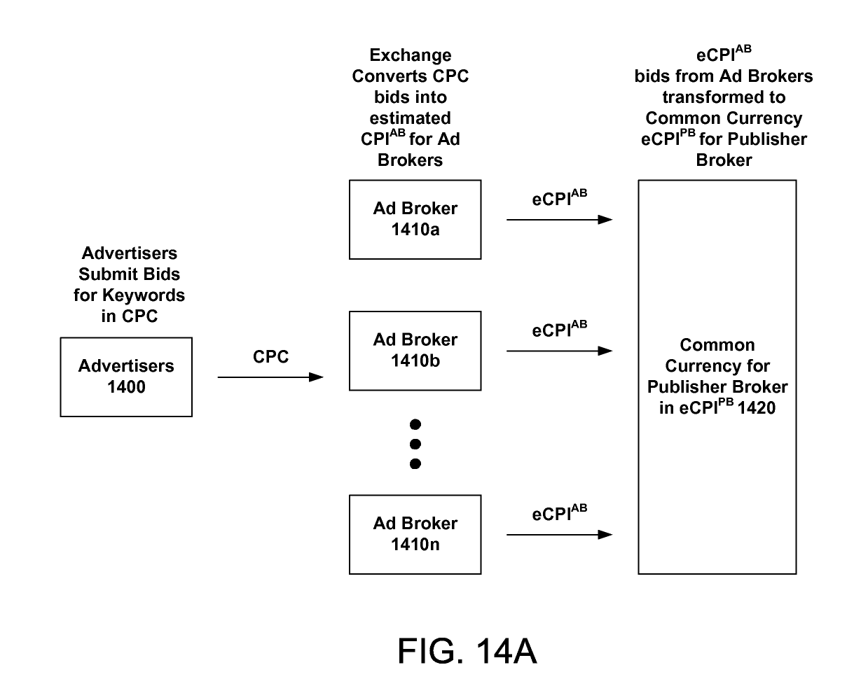

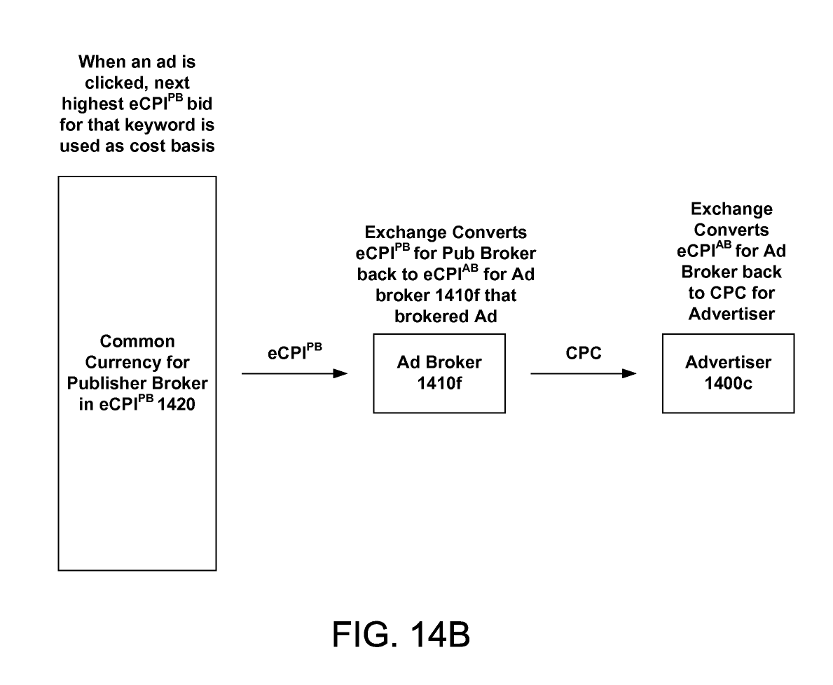

FIGS. 14A and 14B illustrate exemplary, non-limiting operation of the invention in the context of keyword bidding, which also illustrates how billing can work efficiently within an advertising exchange due to the normalization processes of the invention. In this regard, in accordance with respective utility functions, each of advertisers, ad brokers, publisher brokers and the exchange can each receive more objective value in a transaction because the respective utility functions expressed by each party are normalized to a common measure, i.e., each utility function is expressed in a form that is invertible or translatable to an expected revenue, or equivalent.

As shown in FIG. 14A, advertisers 1400 submit listings with bids for keywords to Ad Brokers 1410a, 1410b, . . . , 1410n, which are each expressed in cost per click (CPC). The exchange converts the CPC bids into an estimated value of the cost per impression (eCPI^{AB}) to each ad broker. This estimated value of eCPI^{AB} for each ad broker may depend on the click through rate (CTR) for the listing, the alpha value of the ad broker (a tax withheld by the ad broker for its brokering services), and other factors as well. The invention thus provides an automatic mapping between the bids placed in CPC terms, and the respective values of eCPI^{AB} for the advertising brokers. The aggregate of all of those listings by the various ad brokers 1410a, 1410b, . . . , 1410n are then converted to a common currency 1420 within the Exchange, e.g., eCPI^{PB}, a measure of expected cost per impression from the perspective of publisher brokers.

Then, as shown in FIG. 14B, publisher brokers present the listings to users and users click on an ad, i.e., a revenue triggering event. The exchange converts the listing bid from the common exchange currency eCPI^{PB} back to the advertiser broker currency eCPI^{AB}. The advertiser broker, e.g., ad broker 1410f, in turn bills the advertiser 1400c and divvies up the amount between any OLX exchange tax (that provides the infrastructure), any ad broker (that brokered the ad) and the publisher broker (that published the ad). Since all of the monies are comparable due to the normalization of currency, the invention makes this division of money automatic, further reducing uncertainty and transaction costs. It is noted, for instance, that if the ad broker and publisher broker are the same entity, the OLX exchange tax is not incurred. The full advertiser cost would then go to that entity.

As mentioned, advertisers submit bids for specific keywords to the advertiser broker in CPC and in one embodiment, the exchange converts those CPC bids into eCPI using the estimated CTR. The CTR is an estimate of the clickthrough rate. In one non-limiting embodiment, this estimate is defined as the average CTR for this listing across all publishers. The eCPI bids from the Ad Brokers are then aggregated into one landscape and sorted from highest bid to lowest. During aggregation they are linearly transformed into a common publisher currency using the following equation:

Publisher eCPI=Advertiser eCPI*(1−Advertiser cut %)*(1−OLX exchange tax %)

The transformation to the publisher landscape currency is to normalize all incoming ad eCPIs into a common currency. They can then all be compared in an apples-to-apples manner within the publisher landscape, i.e., a single landscape for all publisher brokers is established. In one embodiment, the ads are then ranked from largest eCPI to smallest eCPI, i.e., the order that will be shown for any Publisher that shows ads for the particular keyword.

When an ad is clicked, the next highest eCPI bid for that keyword is used as the cost basis for the clicked ad (e.g., second place auction). That cost basis is then transformed back into the currency of the Ad Broker who brokered that ad using the following equation for transformation:

Advertiser eCPI=Publisher eCPI/((1−Advertiser cut %)*(1−OLX exchange tax %))

The Ad Broker then converts that eCPI price into CPC using the estimated CTR. This gives the final cost to the Advertiser. Of that final cost, a percentage can go to the OLX as an exchange tax. A percentage of the remainder from the previous step may also go to the Ad Broker, and the remaining amount may go to the Publisher Broker.

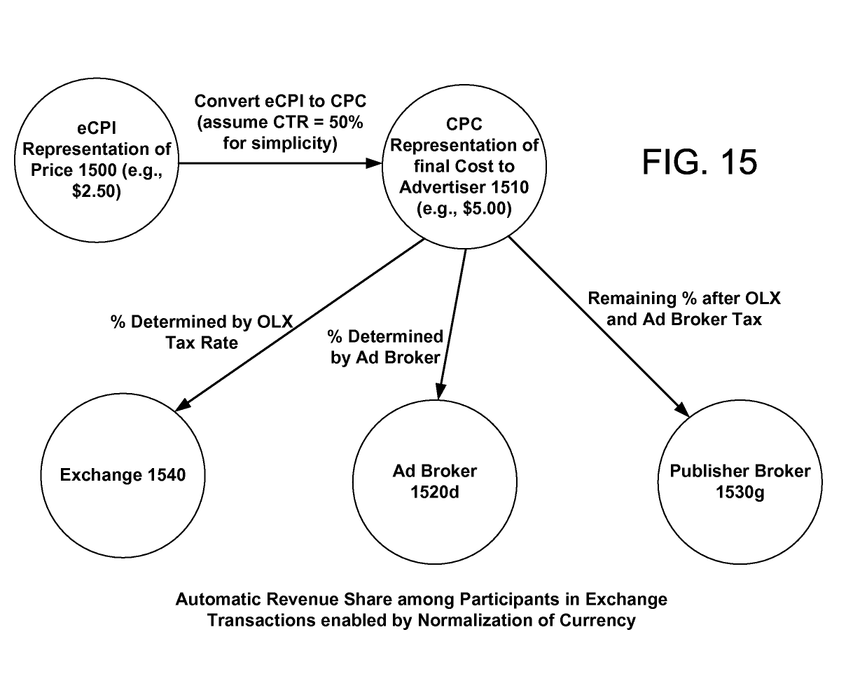

The division of revenue is illustrated in exemplary fashion in FIG. 15. The eCPI price 1500 is converted into a CPC representation 1510 of the final cost to the Advertiser as shown. For instance, assuming a 50% CTR, a eCPI price of $2.50 is converted to a CPC cost of $5.00, of which a percentage can go to the exchange 1540 as an exchange tax, a portion of which may go to the ad broker, such as ad broker 1520d, with the remainder to the publisher broker, e.g., publisher broker 1530g. Thus, the normalization processes of the invention enable a foundation for automatic revenue sharing among disparate parties.

TABLE I
Conversions between Participants in Exchange

| | | | |
|---|---|---|---|
| CPI | CPI | CPI × (1 − α) × | CPI × (1 − α) × (1 − τ) × |
| | | (1 − τ) | β + Q × (1 − β) |
| CPC | CPC × CTR | CPC × CTR × | CPC × CTR × (1 − α) × |
| | | (1 − α) × (1 − τ) | (1 − τ) × β + Q × (1 − β) |
| CPA | CPC × | CPC × CTR × PA × | CPC × CTR × PA × |
| | CTR × PA | (1 − α) × (1 − τ) | (1 − α) × (1 − τ) × |
| | | | β + Q × (1 − β) |

In Table I, alpha (α) is the advertiser broker tax % cut, tau (τ) is the OLX exchange tax, beta (β) is a quality vs. revenue knob for publisher broker and Q is a quality function, i.e., Q=f(Q_{Advertiser}, Q_{Advertiser Broker}) In accordance with the invention, the quality function Q is invertible with respect to or otherwise translatable revenue.

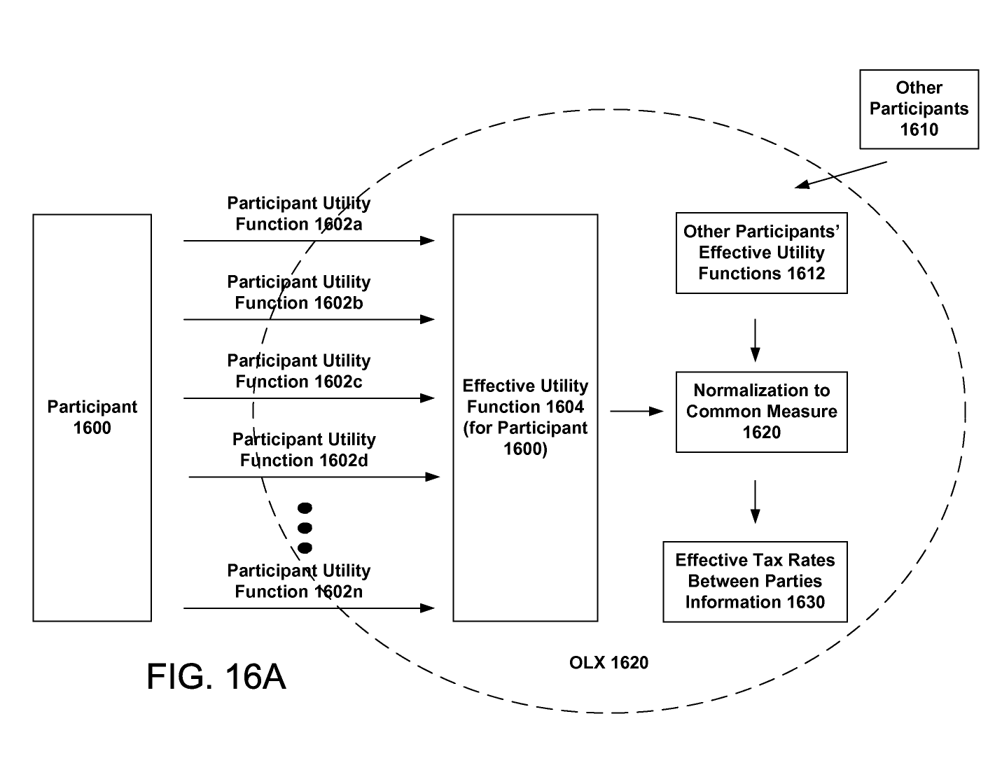

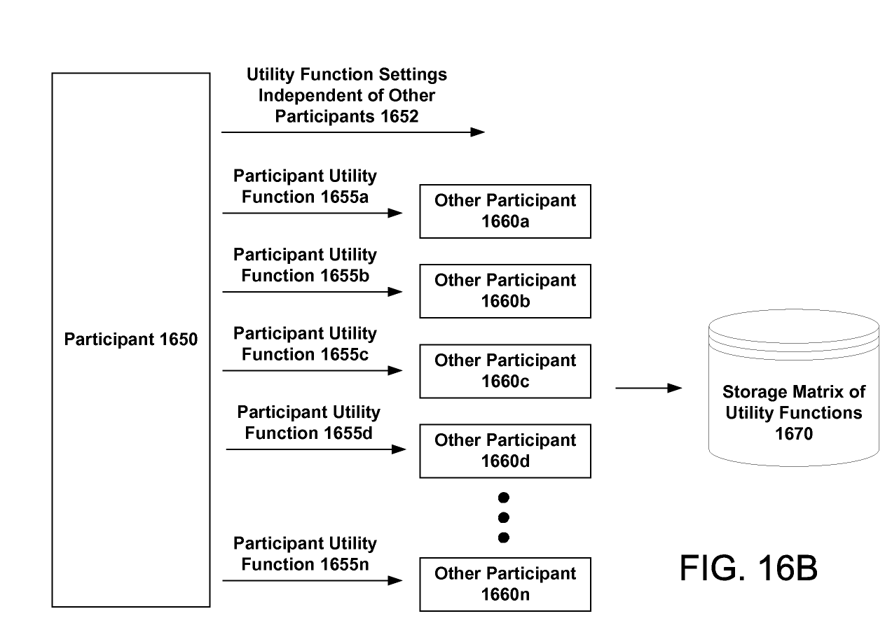

As mentioned earlier, the invention provides a variety of tools, user interfaces, application programming interfaces, etc., that enable each exchange participant to authenticate their presence on the advertising exchange, and express their individual utility function(s) to the exchange. FIG. 16A is a block diagram that shows the ability of participants to specify one or more utility functions to an advertising exchange or federation 1620 in accordance with the invention. A participant 1600 can specify a variety of utility functions 1602a, 1602b, 1602c, 1602d, . . . , 1602n to form an aggregate or collective utility function 1604. The participant utility functions 1602a, 1602b, 1602c, 1602d, . . . , 1602n can be specific to another participant (e.g., apply a party specific tax) or can be specific to a kind of advertising or inventory, or any other expression of a participant's preference for advertising transactions in the exchange 1620. In accordance with the invention, as long as the utility function is invertible with respect to a common measure, such as expected revenue, any preference may be specified as utility functions 1602a, 1602b, 1602c, 1602d, . . . , 1602n.

Similarly, other participants 1610 can each specify their preferences for advertising transactions via effective utility functions 1612. With each of the parties' preferences invertible to a common measure, such as expected CPI, the invention can normalize the utility functions of the participants to the exchange 1620, so that the transaction costs due to the participants' preferences can be understood for a given transaction. In one embodiment, these transaction costs due to the participants' utility functions are expressed as a tax owing to each of the participants to the advertising transactions. For instance, a tax being received by a seller, a discount demanded by a buyer, an exchange tax, etc. can all be expressed so that the participants to a transaction can better understand the costs imposed by the different parties to the transaction. These can be published as effective tax rates 1630 for understanding these costs between the parties.

FIG. 16B is a block diagram illustrating that a participant 1650 can make choices for a utility function that relate to another participants, or other participants, such as participant utility functions 1655a, 1655b, 1655c, 1655d, . . . , 1655n, or, participant 1650 can make choices 1652 that are independent of other participants. The participant utility functions 1655a, 1655b, 1655c, 1655d, . . . , 1655n are mapped to other participants 1660a, 1660b, 1660c, 1660d, . . . , 1660n, respectively. The participant utility functions 1655a, 1655b, 1655c, 1655d, 1655n can be translated to a storage matrix of utility functions 1670 that efficiently maps the utility function expressions at the participant-to-participant level.

In one embodiment, the tools enable advertisers to express the desire to opt out of each other's network. Such a choice translates into an unlimited tax penalty on transactions involving the disparate networks so that they are not pursued as part of exchange transactions. In turn, all other participants within the advertiser's networks do not have such tax penalty applied.

There are many different ways in which a participant can express a utility function. The expression can be direct (“I will not trade with Company XYZ”) or indirect (“I will not trade with small companies”, which implicates small Company XYZ). Such examples show binary utility functions where a participant expresses a preference in one direction or the other. A utility function can also be expressed along a continuum, or according to any function f(x), as long as the expressions are all invertible or translatable to a common measure.

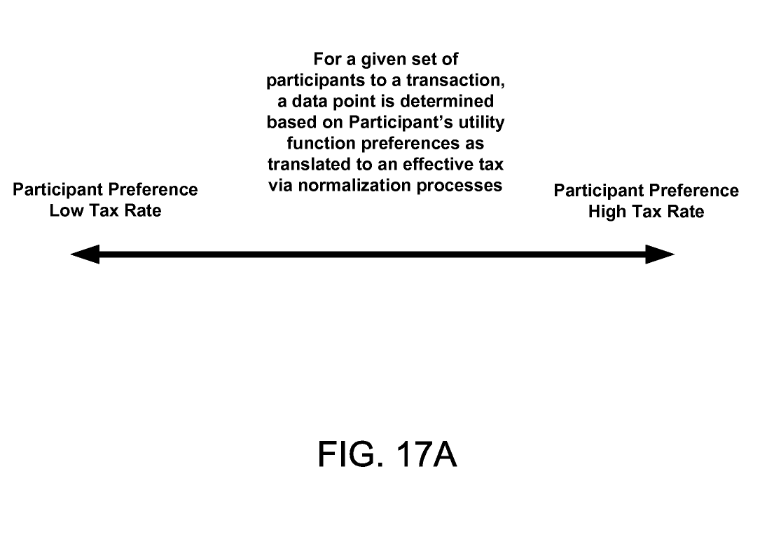

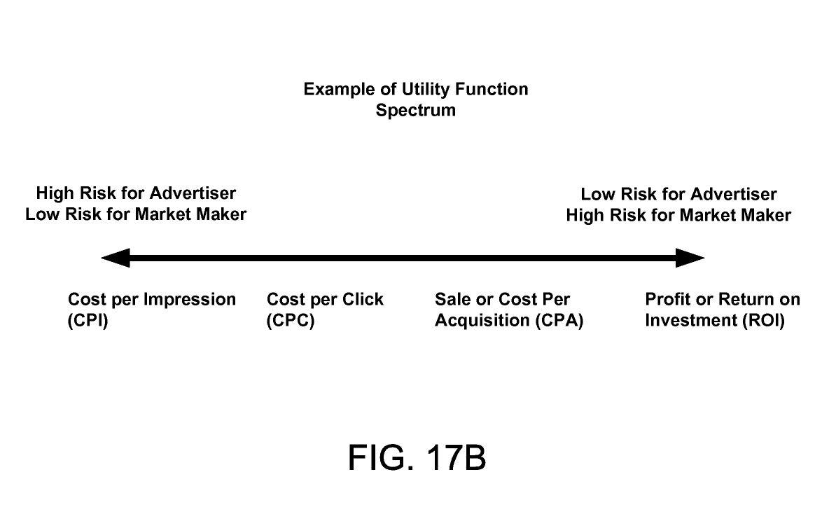

FIG. 17A shows the general concept of expressing a utility function along a continuum. As mentioned, in one embodiment of the invention, all participant preferences and utility functions are invertible with respect to a common measure of expected revenue, and the collective set of utility functions can be expressed as a tax rate for each party of an advertising transaction. Thus, one way to express utility functions in accordance with the invention is to express these tax rates explicitly along a continuum. A set of “tax rate” knobs are thus given to each participant that allow control of an applicable tax rate applied against another party along a continuum of low tax rate to high tax rate.

For instance, the following settings could be used for inputting utility functions by participants: (1) Import Fee high, i.e., “I don't want others touching my inventory,” (2) Import Fee low, i.e., “I want to maximize revenue,” (3) Export Fee high, i.e., “My ads perform so well that I deserve a big cut” and (4) Export Fee low, i.e., I want to provide my advertisers with as much volume as possible.”

FIG. 17B shows another example of a utility function spectrum or continuum that participants can use to express a preference for their interactions with an advertising exchange. One can see that the choice of vocabulary, or units, for advertising transactions affects one's risk profile depending upon which participant one might be. At the left side of the spectrum, for instance, units are expressed in cost per impression (CPI), a measure that is well known to be low risk for the market maker, but high risk for an advertiser who has no guarantees of making a sale. At the opposite side of the spectrum is a choice of units based on actual profit or return on investment (ROI) in which case the market maker bears a lot of risk that the advertising doesn't sell, and the advertiser is guaranteed the desired return in the event of actual profit. Between CPI and ROI are measures of expected revenue as cost per click (CPC) and sale, or cost per acquisition (CPA). Since all of these measures are invertible with respect to a common currency, such as expected CPI, the normalization processes of the invention help participants understand one another's participation goals on comparative terms, even if they are expressed in different vocabularies.

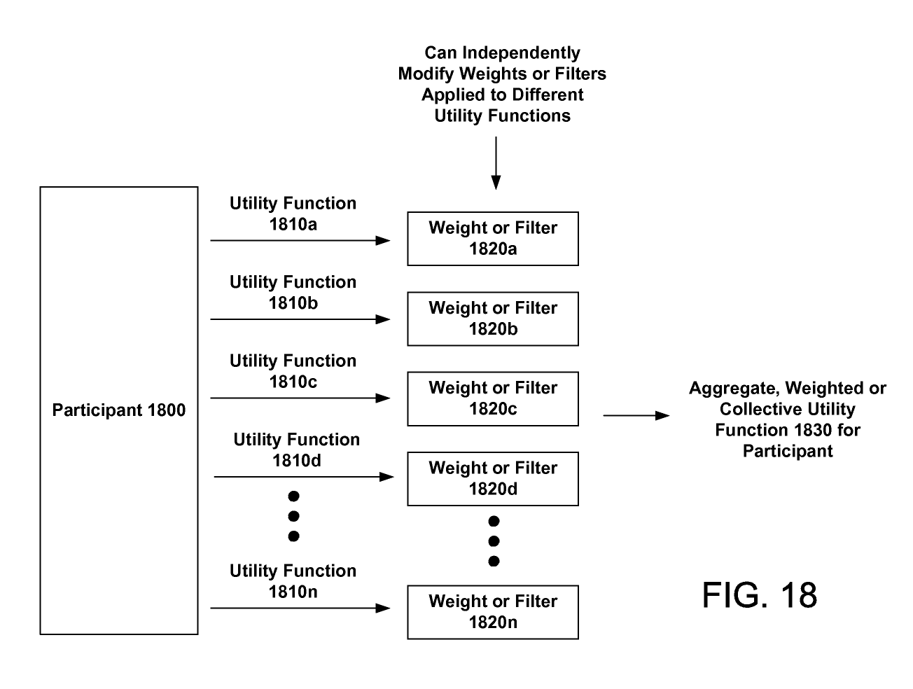

FIG. 18 is a block diagram illustrating the filtering or weighting of utility functions that may be specified by a participant to an online advertising exchange in accordance with the invention. As shown, a participant 1800 may express a variety of utility functions 1810a, 1810b, 1810c, 1810d, . . . , 1810n as variously described herein (e.g., quality of advertising, conversion rate tracking, size of advertiser, popularity of publisher space, relevance, etc.), however, the participant 1800 may not value all of the different kinds of utility functions equally. Accordingly, a participant 1800 can adjust the effects of each of the various kinds of utility functions that can be specified by the participant 1800 to the exchange. Such adjustments are made by weighting, or filtering, the different utility functions with corresponding weights or filters 1820a, 1820b, 1820c, 1820d, . . . , 1820n. The weighted result is then combined into an aggregate or collective utility function 1830 for the participant. Since the weights and filters are independently adjustable, a participant 1800 can fine tune their preferences for advertising transactions by making small adjustments as their preferences evolve over time. In addition, a weight of zero applied to any utility function is a statement that the particular utility function is of no relevance.

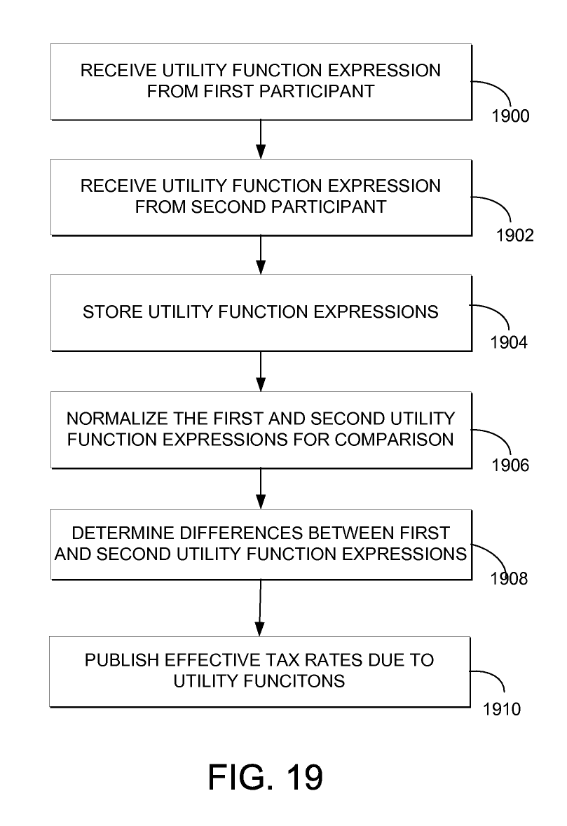

FIG. 19 is a flow diagram illustrating an exemplary process for receiving and normalizing utility functions input by participants to an exchange in accordance with the invention. For instance, at 1900, an expression of a first utility function is received from a first participant in the exchange. At 1902, an expression of a second utility function is received from a second participant in the exchange. These utility functions are stored for their respective participants at 1904. At 1906, the first and second utility function expressions are normalized for comparison within the exchange despite differing definitions of expression for the first and second utility functions. Optionally, at 1908, differences between the first and second utility function expressions can be determined based on the normalization, and also optionally, at 1910, the utility functions, where invertible to expected revenue as the normalizing parameter, can be reduced to effective tax rates owing to the utility functions, which can be published to the participants in the exchange.

The invention may also be implemented in a peer-to-peer architecture, wherein processing performed by the exchange of the invention is shared across multiple participating machines. In such a non-limiting embodiment, each machine participating in the exchange network enabled by the invention can share some of the processing associated with normalization processes performed by the various embodiments of the on-line exchange of the invention.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

There are multiple ways of implementing the present invention, e.g., an appropriate API, tool kit, driver code, operating system, control, standalone or downloadable software object, etc. which enables applications and services to use the advertising techniques of the invention. The invention contemplates the use of the invention from the standpoint of an API (or other software object), as well as from a software or hardware object that operates according to the advertising techniques in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to advertise. While exemplary programming languages, names and/or examples are chosen herein as representative of various choices, these languages, names and examples are not intended to be limiting. One of ordinary skill in the art will also appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the advertising techniques of the present invention, e.g., through the use of a software object, data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to one or more of the figures. While for purposes of simplicity of explanation, in some cases, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide the disclosed embodiments for advertising methods. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for facilitating transactions for advertisement space in an advertising exchange including a publisher broker to represent at least one publisher and an advertiser broker to represent at least one advertiser, comprising:
receiving a first expression of a first utility function based on a first utility model from a first participant in the advertising exchange that defines at least one preference of the first participant pertaining to conducting transactions in the advertising exchange, wherein the first expression is invertible with respect to a common measure;
receiving a second expression of a second utility function based on a second utility model, different from the first utility model, from a second participant in the advertising exchange that defines at least one preference of the second participant pertaining to conducting transactions in the advertising exchange, wherein the second expression is invertible with respect to the common measure, and wherein the first participant and the second participant are advertising entities of disparate advertising networks; and
normalizing the first and second expressions to the common measure enabling a quantifiable comparison of the first utility function and the second utility function.

2. The method of claim 1, wherein the normalizing includes inverting the first and second expressions to a common measure of expected revenue from advertising transactions.

3. The method of claim 2, wherein the normalizing includes inverting the first and second expressions to a common measure of expected cost per impression for advertising.

4. The method of claim 1, further comprising:
translating the first and second expressions to effective tax rates as between the first and second participants for advertising transactions in the advertising exchange.

5. The method of claim 4, displaying the effective tax rates to the first and second participants for transactions between the first and second participants.

6. A computer readable medium comprising computer executable instructions for carrying out the method of claim 1.

7. A system to facilitate trading of advertising, comprising:
a publisher broker to represent at least one publisher, wherein the publisher broker determines at least one ask for an advertisement space of the at least one publisher;
an advertiser broker to represent at least one advertiser, wherein the advertiser broker manages at least one bid for the advertisement space by the at least one advertiser; and
an exchange to facilitate a transaction for the advertisement space between the publisher broker and the advertiser broker, wherein the publisher broker and the advertiser broker are advertising entities of disparate advertising networks,
wherein a first utility function is received by the exchange that defines at least one objective of the publisher broker or at least one objective of the advertiser broker, wherein a second utility function, different from the first utility function, is received by the exchange that defines at least one objective of the publisher broker or at least one objective of the advertiser broker, and wherein the exchange normalizes the first and second utility functions to a standard utility function representation enabling a direct comparison of the first and second utility functions.

8. The system of claim 7, wherein the first and second utility functions are compared according to the standard utility function representation for a transaction between the publisher broker and advertiser broker.

9. The system of claim 7, wherein at least one difference between the first and second utility functions is determined by the exchange based on the standard utility function representation.

10. The system of claim 7, wherein the first and second utility functions are defined as at least one function that is invertible to expected revenue from advertising transactions.

11. The system of claim 10, wherein the first and second utility functions are defined as at least one function that is invertible to expected cost per impression for advertising in the advertising exchange.

12. A method for facilitating transactions for advertisement space in an advertising exchange among a plurality of participants including a first participant and a second participant that are advertising entities of disparate advertising networks, comprising:
receiving from the first participant a first set of local objectives defined according to a first format, the first set of local objectives representing at least one objective for conducting transactions in the advertising exchange;
receiving from the second participant a second set of local objectives according to a second format, the second set of local objectives representing at least one objective for conducting transactions in the advertising exchange;
if the first and second sets of local objectives are defined in disparate formats, translating the first and second sets of local objectives to a standardized format that defines a common measure of value of objectives across the plurality of participants from disparate advertising networks in the advertising exchange.

13. The method of claim 12, further comprising:
for a transaction between the first and second participant, comparing the first and second sets of local objectives according to the standardized format.

14. The method of claim 13, further comprising:
exposing differences between the first and second set of local objectives in terms of the standardized format.

15. The method of claim 14, further comprising:
translating the differences to the first format for the first participant and to the second format for the second participant.

16. The method of claim 12, wherein the first and second sets of local objectives are defined as at least one function that is invertible to the common measure of value.

17. The method of claim 16, wherein the first and second sets of local objectives are defined as at least one function that is invertible to expected revenue from advertising transactions in the advertising exchange.

18. The method of claim 17, wherein the first and second sets of local objectives are defined as at least one function that is invertible to expected cost per impression for advertising in the advertising exchange.

19. The method of claim 12, further comprising:
translating the first and second sets of local objectives to effective tax rates as between the first and second participants for advertising transactions in the advertising exchange.

20. A computer readable medium comprising computer executable instructions for carrying out the method of claim 12.
